(19) United States
(12) Patent Application Publication
(10) Pub. No.: US 2026/0234938 A1
(43) Pub. Date: Aug. 13, 2026

(54) Fail-Safe Awning and Method of Making Same

(71) Applicant: Carefree Company, Broomfield, CO (US)

(72) Inventors: David Thomas MCMILLAN, Broomfield, CO (US); Gregory Keith HEIMBUCK, Arvada, CO (US); Kevin MAYER, Boulder, CO (US); James Tyler KINNEY, Arvada, CO (US)

(73) Assignee: Carefree Company, Broomfield, CO (US)

(21) Appl. No.: 19/155,242

(22) PCT Filed: Feb. 12, 2024
(86) PCT No.: PCT/US2024/015333

§ 371 Date: Aug. 9, 2025

Related U.S. Application Data
(60) Provisional application No. 63/444,633, filed on Feb. 10, 2023.
(60) Provisional application No. 63/530,178, filed on Aug. 1, 2023.

(51) Int. Cl. E04F 10/06

(52) U.S. Cl. CPC E04F 10/0666; E04F 10/0614; E04F 10/0625; E04F 10/0629; E04F 10/0651; E04F 10/0618

(57) ABSTRACT

An awning assembly is provided that includes an awning connection system coupling an awning canopy to a support structure. The awning connection system comprises a roll bar coupled to the awning canopy, a set of arms coupled to the roll bar that support the awning canopy as the awning canopy extends from a retracted to an extended position, a force providing apparatus that when providing force moves the awning canopy into the extended position, and a biasing mechanism that biases the set of arms into the retracted position absent the force of the force providing apparatus.

### CROSS-REFERENCE TO RELATED APPLICATIONS

The present application claims priority under 35 U.S.C. § 119(e) to currently pending U.S. Provisional Patent Application Ser. No. 63/530,178 filed Aug. 1, 2023 entitled FAIL-SAFE AWNING AND METHOD OF MAKING SAME and to currently pending U.S. Provisional Patent Application Ser. No. 63/444,633 filed Feb. 10, 2023 entitled FAIL-SAFE AWNING AND METHOD OF MAKING SAME. The above-identified applications are incorporated herein by reference in their entireties for all purposes.

### FIELD OF THIS DISCLOSURE

The present disclosure relates to a fail-safe awning and method of making same, and more particularly, a fail-safe awning that is structured to retract in the event of a mechanical or electrical failure.

### BACKGROUND

An awning is a welcome addition to a house, recreational vehicle, or other dwelling. The awning typically provides increased enjoyment of an outdoor area surrounding the dwelling. The awning can cast a shaded area that creates an escape from direct sunlight, thereby providing a space in which an occupant of the dwelling may relax. The shaded area created by the awning contributes to the relaxation of the occupant in that there is a perceived decrease in temperature and, thus, generally becomes more comfortable. The awning as well advantageously protects occupants underneath from precipitation.

Known awning structures generally consist of a base that is permanently affixed to the dwelling, and a canopy that is removably attached to the base. Conventional awning structures are discussed in detail further in U.S. Pat. Nos. 6,971,433, 7,628,194, and 11,428,011 assigned to Carefree/Scott Fetzer Company. U.S. Pat. Nos. 6,971,433, 7,628,194, and 11,428,011 are incorporated herein by reference in their entireties for all purposes.

Motorized awnings used on a home or recreational vehicle are biased to extend the arms of an awning into an open or extended position. This can be unsafe, as in the event of an electrical or mechanical failure, the awning will open. Such openings could be harmful, such as if the awning is on a moving vehicle, or a user is attempting to the adjust the awning during failure and is impacted by a lead rail coupled to the awning.

### SUMMARY

One aspect of the present disclosure includes an awning assembly that includes an awning connection system coupling an awning canopy to a support structure. The awning connection system coupling an awning canopy to a support structure during use, the awning connection system comprising a roll bar coupled to the awning canopy, a set of arms coupled to the roll bar that support the awning canopy as the awning canopy extends from a retracted to an extended position, a powered actuator that when providing a powered force that moves the awning canopy into the extended position, and a retraction actuator that biases the set of arms into the retracted position, wherein responsive to interruption or cessation of the powered force provided by the powered actuator, the awning canopy moves into the retracted position.

Another aspect of the present disclosure includes an awning canopy assembly comprising an awning connection system. The awning connection system coupling an awning canopy to a support structure during use. The awning connection system include a roll bar coupled to the awning canopy, first and second extension arms coupled to the roll bar that supports the awning canopy as the awning canopy extends from a retracted to an extended position, a retraction actuator coupled to the awning connection system that provides a retraction force biases the awning canopy into the retracted position, and an extension actuator coupled to one of the first or second extension arms, the extension actuator when providing an extension force biases the awning canopy into the extended position, the retraction force greater than the extension force, the extension force in an opposite direction than the retraction force. Further, a powered force is applied to the awning canopy assembly in a same direction as the extension force which moves the awning canopy into the extended position, the combination of the extension force and the powered force greater than the retraction force, wherein responsive to an interruption of the powered force, the awning canopy moves into the retracted position.

Yet another aspect of the present invention includes a method of providing an awning canopy assembly. The method includes providing a roll bar coupled to an awning canopy, providing a set of arms coupled to the roll bar at a first end of the set of arms, and for coupling to a support structure during use at a second end of the set of arms, the set of arms supporting the awning canopy as the awning canopy extends from a retracted to an extended position, and providing a retraction actuator coupled to the awning canopy assembly that biases the set of arms into the retracted position by providing a retraction force. The method further includes providing a powered actuator coupled to the awning canopy assembly, the powered actuator when providing a powered force moves the awning canopy into the extended position, the powered force greater than the retraction force, wherein responsive to a cessation of the powered force, the awning canopy moves into the retracted position.

Yet another aspect of the present invention includes a method of providing an awning canopy assembly. The method includes providing a roll bar coupled to an awning canopy, and providing a set of arms coupled to the roll bar at a first end of the set of arms, and for coupling to a support structure during use at a second end of the set of arms, the set of arms supporting the awning canopy as the awning canopy extends from a retracted to an extended position. The method further includes providing a retraction actuator for coupling to the awning connection system that provides a retraction force biases the awning canopy into the retracted position, and providing an extension actuator for coupling to one of the first or second extension arms, the extension actuator when providing an extension force biases the awning canopy into the extended position, the retraction force greater than the extension force, the extension force in an opposite direction than the retraction force. The method additionally includes providing a powered actuator for coupling to the awning canopy, the powered actuator provides a powered force to the awning canopy assembly in a same direction as the extension force which moves the awning canopy into the extended position, the combination of the extension force and the powered force greater than the retraction force, wherein responsive to an interruption of the powered force, the awning canopy moves into the retracted position.

### BRIEF DESCRIPTION OF THE SEVERAL VIEWS OF THE DRAWINGS

The foregoing and other features and advantages of the present disclosure will become apparent to one skilled in the art to which the present disclosure relates upon consideration of the following description of the disclosure with reference to the accompanying drawings, wherein like reference numerals, unless otherwise described refer to like parts throughout the drawings and in which:

FIG. 1 is a perspective view of a horizontal awning assembly of an awning system in a retracted position, in accordance with one example embodiment of the present disclosure;

FIG. 2 is a perspective view of a horizontal awning assembly of an awning system in a partially retracted position, in accordance with one example embodiment of the present disclosure;

FIG. 3 is a perspective view of a horizontal awning assembly of an awning system in an extended position, in accordance with one example embodiment of the present disclosure;

FIG. 4 is a perspective view of an arm of a horizontal awning assembly of an awning system in an extended position, in accordance with one example embodiment of the present disclosure;

FIG. 5 is a perspective view of a horizontal awning assembly of an awning system in an extended position, in accordance with one example embodiment of the present disclosure;

FIG. 6 is a top perspective view of a horizontal awning assembly of an awning system in an extended position, in accordance with one example embodiment of the present disclosure;

FIG. 7 is an elevation view of a horizontal awning assembly of an awning system in an extended position, in accordance with one example embodiment of the present disclosure;

FIG. 8 is a perspective view of a lateral awning assembly of an awning system in an extended position, in accordance with one example embodiment of the present disclosure;

FIG. 9 is a bottom plan view of a lateral awning assembly of an awning system in an extended position, in accordance with one example embodiment of the present disclosure;

FIG. 10 is a bottom perspective view of a lateral awning assembly of an awning system in an extended position, in accordance with one example embodiment of the present disclosure;

FIG. 11 is a front elevation view of a lateral awning assembly of an awning system in a retracted position, in accordance with one example embodiment of the present disclosure;

FIG. 12 is a side elevation view of a lateral awning assembly of an awning system in an extended position, in accordance with one example embodiment of the present disclosure;

FIG. 13 is an exploded perspective view of a first retraction actuator of an awning assembly of an awning system in an extended position, in accordance with one example embodiment of the present disclosure;

FIG. 14 is a partial cross-sectional view of a second retraction actuator of an awning assembly of an awning system in a retracted position, in accordance with one example embodiment of the present disclosure;

FIG. 15 is a partial cross-sectional view of a second retraction actuator of an awning assembly of an awning system in an extended position, in accordance with one example embodiment of the present disclosure;

FIG. 16 is a bottom perspective view of a lateral awning assembly of an awning system having a first or second retraction actuator in an extended position, in accordance with one example embodiment of the present disclosure;

FIG. 17 is a perspective view of a horizontal awning assembly of an awning system having a first or second retraction actuator in an extended position, in accordance with one example embodiment of the present disclosure;

FIG. 18 is a front elevation view of a horizontal awning assembly of an awning system having a third retraction actuator in a retracted position, in accordance with one example embodiment of the present disclosure;

FIG. 19 is a side elevation view of a horizontal awning assembly of an awning system having a third retraction actuator in a retracted position, in accordance with one example embodiment of the present disclosure;

FIG. 20A is a side elevation view of a lateral awning assembly of an awning system having a fourth retraction actuator in a retracted position, in accordance with one example embodiment of the present disclosure;

FIG. 20B is a bottom perspective view of a lateral awning assembly of an awning system having a fourth retraction actuator in an extended position, in accordance with one example embodiment of the present disclosure;

FIG. 21 is a perspective view of a horizontal awning assembly of an awning system having a fourth retraction actuator in an extended position, in accordance with one example embodiment of the present disclosure;

FIG. 22 is a top perspective view of a horizontal awning assembly of an awning system having a first extension actuator in an extended position, in accordance with one example embodiment of the present disclosure;

FIG. 23 is a bottom perspective view of a lateral awning assembly of an awning system having a first extension actuator in an extended position, in accordance with one example embodiment of the present disclosure;

FIG. 24 is a bottom perspective view of a lateral awning assembly of an awning system having a first powered actuator in an extended position, in accordance with one example embodiment of the present disclosure;

FIG. 25 is a side elevation view of a horizontal awning assembly of an awning system having a second powered actuator in an extended position, in accordance with one example embodiment of the present disclosure;

FIG. 26 is a side elevation view of a horizontal awning assembly of an awning system having a third powered actuator in an extended position, in accordance with one example embodiment of the present disclosure;

FIG. 27 is a side elevation view of a horizontal awning assembly of an awning system having a fourth powered actuator in an extended position, in accordance with one example embodiment of the present disclosure;

FIG. 28 is a side elevation view of a horizontal awning assembly of an awning system having a fifth powered actuator in an extended position, in accordance with one example embodiment of the present disclosure;

FIG. 29 is a side elevation view of a horizontal awning assembly of an awning system having a fifth powered actuator in a retracted position, in accordance with one example embodiment of the present disclosure;

FIG. 30 is a bottom perspective view of a lateral awning assembly of an awning system having a sixth powered actuator in an extended position, in accordance with one example embodiment of the present disclosure;

FIG. 31 is a bottom perspective view of a lateral awning assembly of an awning system having a seventh powered actuator in an extended position, in accordance with one example embodiment of the present disclosure;

FIG. 32 is a bottom perspective view of a lateral awning assembly of an awning system having a eighth powered actuator in an extended position, in accordance with one example embodiment of the present disclosure;

FIG. 33 is a side elevation view of a lateral awning assembly of an awning system having a eighth powered actuator in a retracted position, in accordance with one example embodiment of the present disclosure;

FIG. 33 is a plan view of a motorized horizontal arm awning assembly in a partially extended position, in accordance with one example embodiment of the present disclosure;

FIG. 34 is a depiction of awning states responsive to various inputs;

FIG. 35 is a bottom perspective view of FIG. 33;

FIG. 36 is a top perspective view of FIG. 33; and

FIG. 37 is a bottom right perspective view of FIG. 33

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

Referring now to the figures generally wherein like numbered features shown therein refer to like elements having similar characteristics and operational properties throughout unless otherwise noted. The present disclosure relates to a fail-safe awning and method of making same, and more particularly, a fail-safe awning that is structured to retract in the event of a mechanical or electrical failure.

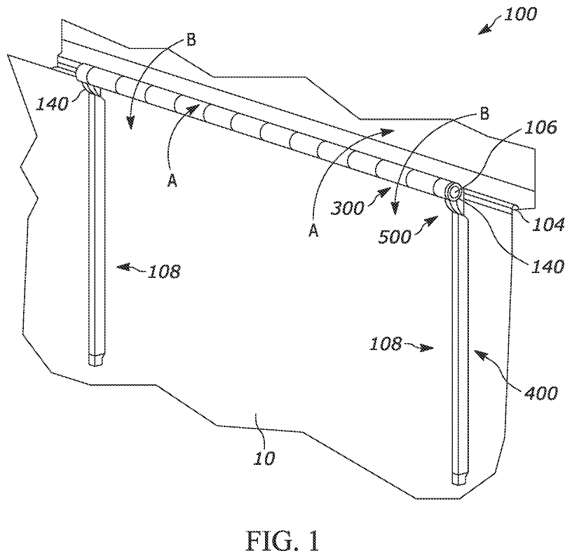

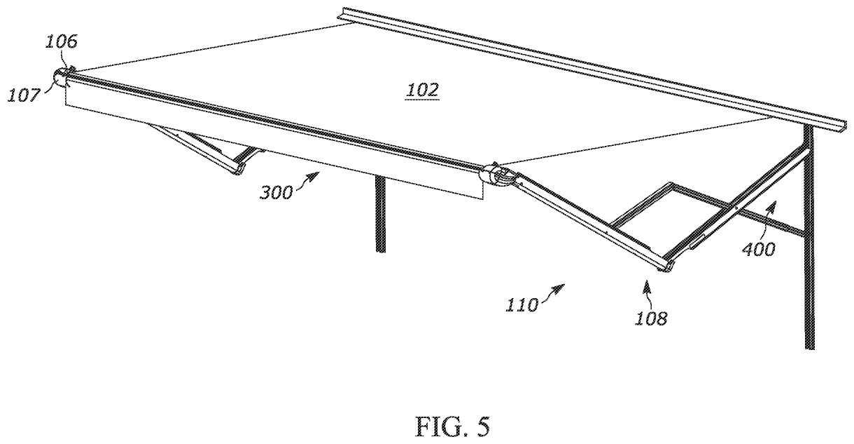

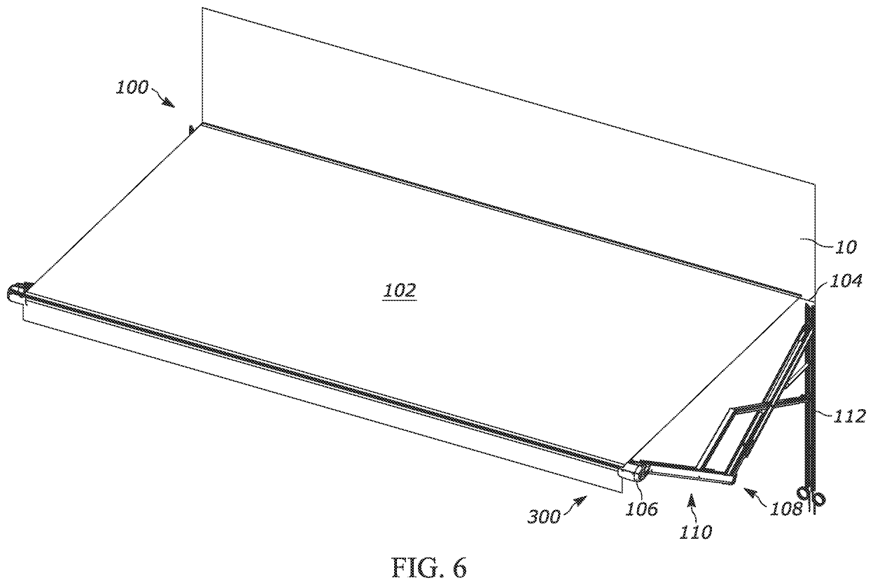

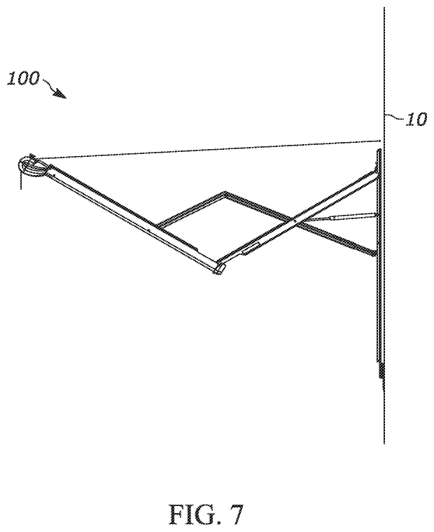

Now referring to FIGS. 1-7, an awning assembly 100 is illustrated. The awning assembly 100 includes a flexible awning canopy 102 that is mounted to a vertical support surface 10, which might be for example, the side wall of a recreational vehicle, mobile home, a recreational vehicle slide-out, or more permanent building structure. The flexible awning canopy 102 includes an inner or proximal edge 102a secured to a support rail 104 and an outer edge 102b secured to a roll bar 106, which, in this example embodiment, is coupled to a retraction actuator 300. The roll bar 106 is operatively connected to, and maintained by, a support system 108 in the form of arms, such as pair of scissor-type arms 110, horizontally extending arms (as discussed in detail below), or the like.

In the illustrated example embodiment of FIG. 1, the retraction actuator 300 (e.g., a tension spring, compression spring, or any other actuator described herein) exerts a first force F1 originating from the retraction actuator. In one example embodiment, the retraction actuator 300 is housed within or in communication with the roll bar 106. In this example embodiment, the retraction actuator 300 exerts the first force F1 to orient the awning 100 into a retracted position (as illustrated in FIG. 1).

In the illustrated example embodiment, the scissor-type arms 110 are constructed of metal, such as aluminum, but are contemplated as being made of other materials of similar weight and strength. It would be appreciated by one having ordinary skill in the art, that various other types of extensions arms are contemplated and would likewise be constructed of metal, such as aluminum, but could be made of other materials of similar weight and strength.

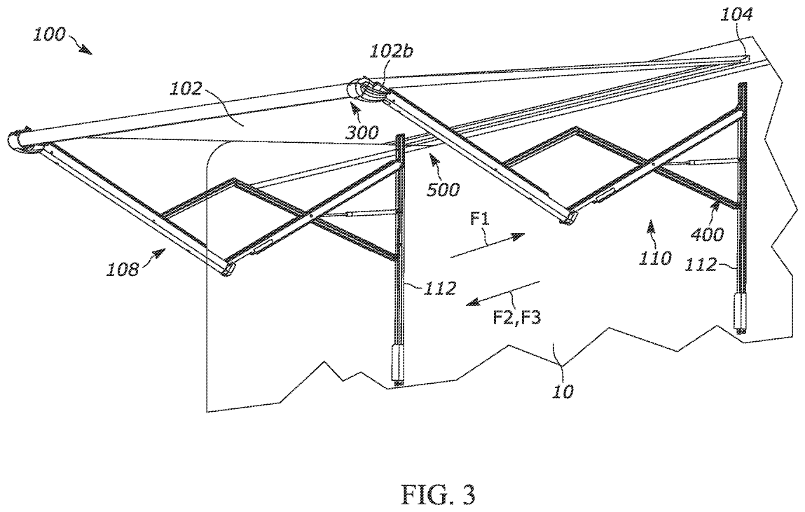

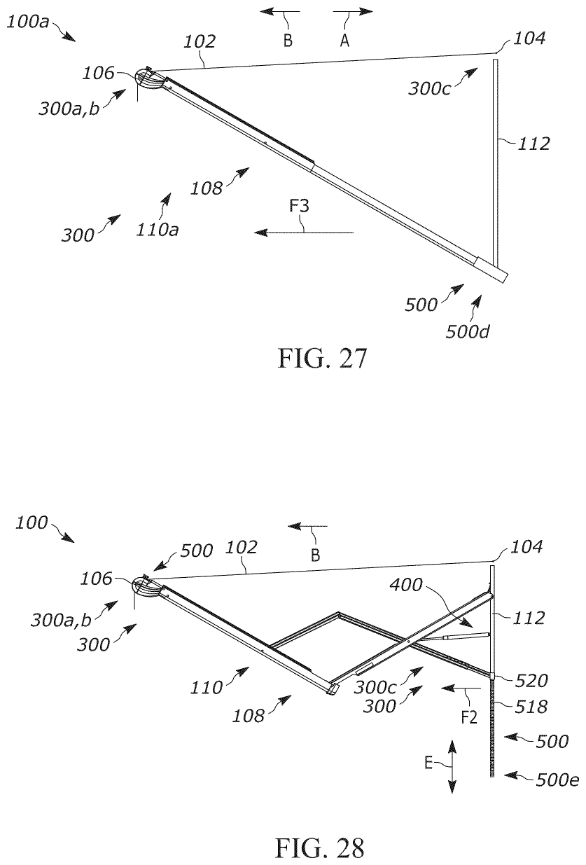

An example support system 108 includes one of two scissors-type arms 110 mounted on a vertical track 112 that during use would attach to the support surface 10. It would be appreciated that different arm structures would function with various connections types to a dwelling, such as a single support arm 110a, illustrated in the example embodiment of FIG. 27. The support system 110 is shown extended in FIGS. 3-4, and 6-7 with the awning assembly 100 in the extended position. While the assembly 100 is fully retracted, as illustrated in FIG. 1, it will be appreciated that the support system 110 is vertically disposed and in close adjacent relationship with a track 112 during use. In the illustrated example embodiment, the track 112 is coupled to the support surface 10.

As will be appreciated, and as shown in the illustrated example embodiment of FIG. 1, as the retraction actuator 300 is driven in a first direction, represented by arrow A, toward the retracted position, wherein the awning canopy 102 is rolled onto the roll bar 106, causing the awning 102 to retract.

The awning 102 retracts or extends in cooperation with an extension actuator 400 (various embodiments of the extension actuator will be discussed in greater detail below) associated with the respective scissor-type arms 110. The extension actuator 400 (e.g., a gas spring, a compression spring, and/or any other actuator described herein) exerts a second force F2 to orient the awning 100 into an extended position, wherein the first force F1 is greater than the second force F2. The awning 100 supports a powered actuator (e.g., an electric motor, a hydraulic motor, a linear actuator providing a physical, fluid, electrical, and/or magnetic force, etc.) that applies a third force F3 to extend the awning 100 into the extended position, as illustrated in FIG. 3. In one example embodiment, a user applies a manual force as the third force F3 to extend the awning 100 into the extended position, as illustrated in FIG. 3. In this example embodiment, the sum of the second force F2 and the third force F3 are greater than the first force F1. Thus, if at any point, the powered actuator 500 or an idler 107 should fail, the awning 100 will revert to a retracted position.

Responsive to the roll bar 106 being rotated by the powered actuator 500, which is discussed in greater detail below, the second force F2 of the extension actuator 400 and the third force F3 of the powered actuator combine to overcome the first force F1 of the retraction actuator 300 and the awning assembly 100 moves in the second direction B to extend the awning canopy 102 by unwrapping the awning canopy from about the roll bar 106. In this example embodiment, the scissor-type arms 110 are forced to extend in direction B against the bias of the retraction actuator 300 until the awning is in the fully extended position illustrated in FIG. 3.

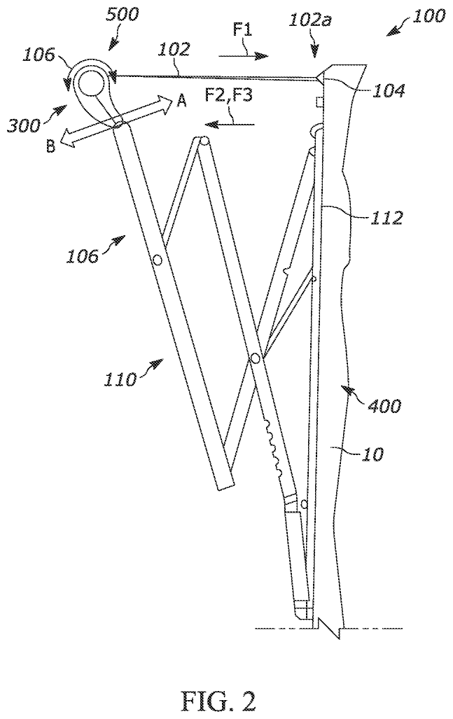

To retract the awning assembly 100, the roll bar 106 is rotated as shown in FIG. 2 to retract the awning in direction A by unwrapping the awning canopy 102 from the roll bar. The scissor-type arms 110 are assisted in retracting by the bias of the retraction actuator 300 until fully retracted to the retracted position illustrated in FIG. 1.

It would be appreciated by one having ordinary skill in the art that additional example embodiments of the awning assembly 100 are contemplated. In one such example embodiment, the awning assembly 100 has scissor-type arms 110 that retract up and/or rotate inwards such as towards the roll bar 106 indicated by arrows B in FIG. 1 by a fixture assembly (not shown). Stated another way, the support system 108 when in the contracted position (see FIG. 1) can rotate such that the support system that includes the vertical tracks 112 are parallel with the roll bar 102.

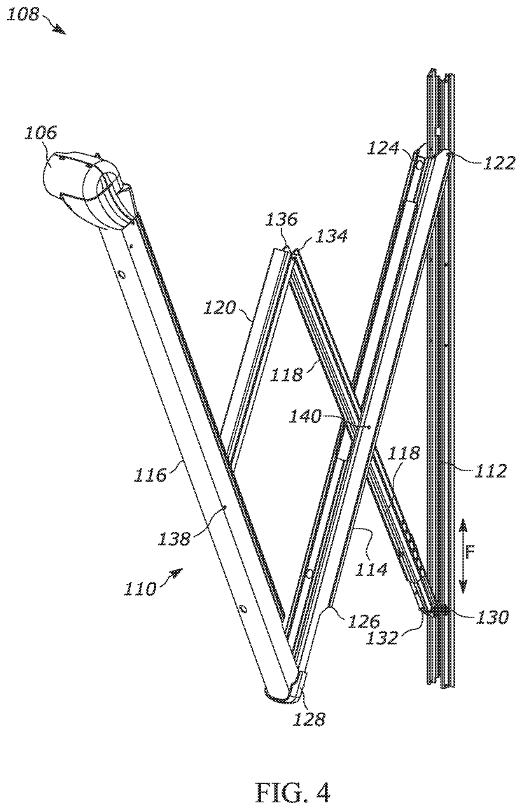

One example embodiment of the scissor type arms 110 are shown in the example embodiment of FIG. 4. In this example embodiment, the support system 108 of the awning canopy assembly 100 is illustrated. In one example embodiment, the support system 108 comprises a first support of a first side of the awning 100, wherein a mirror image of the support system 108 comprises a second support of a second side of the awning. The support system 108 comprises first and second main members 114, 116 and first and second supplemental members 118, 120, respectively. Each of the members 114-120 in the illustrated example embodiment are formed from metal, plastic, or the like. In one example embodiment, the members 114-120 are formed from extruded aluminum channeling.

In the illustrated example embodiment, the first member 114 is rotatably attached to the vertical track 112 by a fixed pin 122 that passes through both the first member and track at a first end 124 of the first member. At a second end 126 of the first main member 114, a rotating pin 128 couples the first main member to the second main member 116, such that the two main members have relative rotation about the pin 128 as the awning assembly 100 moves between the fully retracted first position illustrated in FIG. 1 to the fully extended the second position illustrated in FIG. 3.

A slideable pin 130 allows for translation of the first supplemental member 118 about and within the vertical track 112 in the directions of arrows F in FIG. 4. The slideable pin 130 further allows for rotational pivoting of the first supplemental member 118 at a first end 132. At a second end 134 of the first supplemental member 118 a rotating pin 136 couples the first supplemental member to the second supplemental member 120, such that the two supplemental members have relative rotation about the pin 136 as the awning assembly 100 moves between the extended and retracted positions. The opposite end of the second supplemental member 120 is rotatably coupled to a rotatable pin 138 that is fixedly attached to the second main member 116. Located substantially about the medial point along the first main member 114 and the first supplemental member 118 is a hinge pin 140. The hinge pin 140 allows for relative rotation of the first members 114, 118 during the extension and retraction of the awning canopy assembly 100.

Additional information about the support structure 108 can be found in U.S. Published Patent Application No. US2017/0275885 entitled Awning Canopy Assembly, which is assigned to CAREFREE/SCOTT FETZER COMPANY, the Applicant of the subject application (hereinafter “the '885 Publication). The '885 Publication is incorporated herein in its entirety and for all purposes.

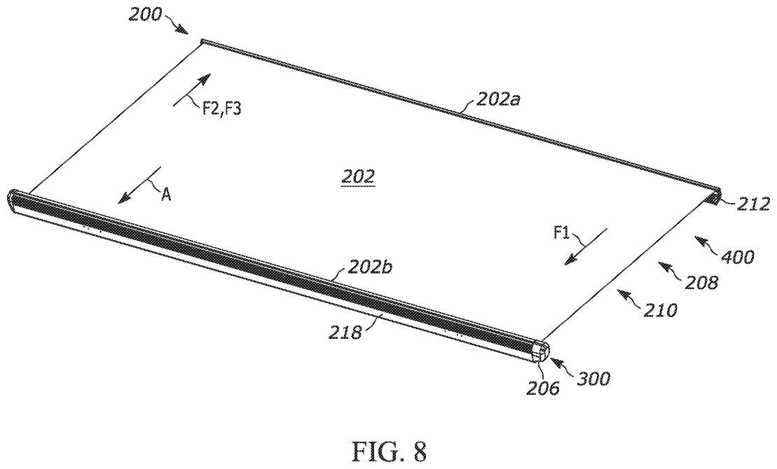

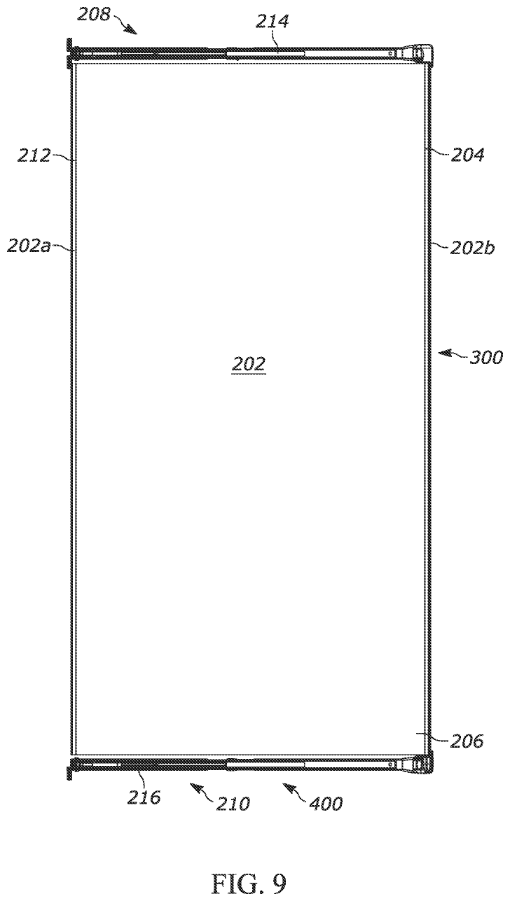

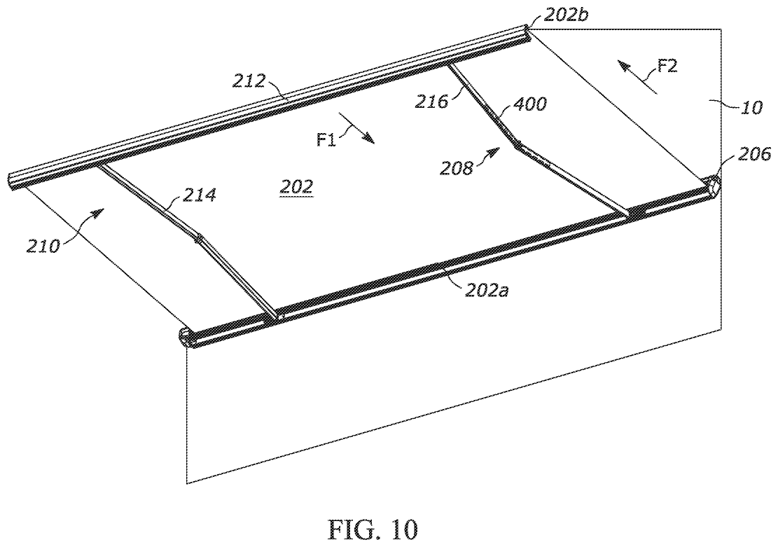

As illustrated in the example embodiment of FIGS. 8-12, a lateral arm awning 200 has a support structure 210 having first and second lateral arms 214, 216 that extend away from an awning body 218. In one example embodiment, the first and second lateral arms 214, 216 may, respectively, be composed of a proximal arm and a distal arm pivotally joined together at an arm elbow, such a configuration is disclosed in U.S. Pat. No. 10,316,522, assigned to Carefree a Scott Fetzer Co., and incorporated herein by reference in its entirety and for all purposes. The proximal and distal arms rotate with respect to each other at the arm elbows such that each proximal arm is closer to being axially aligned with its respective distal arm rather than each set of proximal and distal arms being substantially parallel and adjacent to each other when the awning is in the stowed position. In one example embodiment, the first and second lateral arms 214, 216 fold together to be stowed with the rollbar 206 and the retracted canopy 202 against the wall or other mounting surface 10 and/or within the awning body 218. In one example embodiment, a front cap (not shown) encapsulates/covers the rollbar 206 while defining an opening through which the first and second lateral arm 214, 216 extend.

The first and second lateral arms 214, 216 support the lead rail 212. In this example embodiment, the lead rail is coupled to a first end 202a of a canopy 202. The canopy 202 is attached to a rollbar 206 at a second end 202b of the canopy. The canopy 202 is extended responsive to the lead rail 212 being extended away from the awning body 218, and retracted responsive to the lead rail being retracted toward the awning body. Typically, the first and second lateral arms 214, 216 are housed within the awning body 218 when the canopy is retracted.

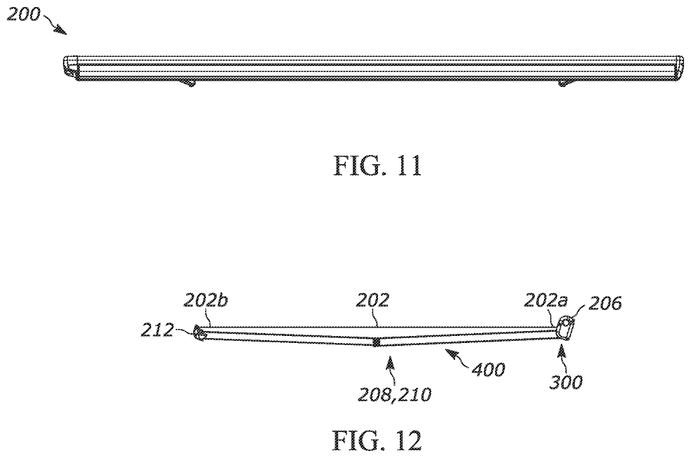

In the illustrated example embodiment of FIGS. 8-12, the retraction actuator 300 exerts the first force F1 originating from the retraction actuator on the lateral arm awning 200. In one example embodiment, the retraction actuator 300 is housed within or in communication with the roll bar 206. In this example embodiment, the retraction actuator 300 exerts the first force F1 to orient the awning 200 into the retracted position (as illustrated in FIG. 11).

As will be appreciated, and as shown in the illustrated example embodiment of FIG. 8, as the retraction actuator 300 is driven in a first direction, represented by arrow A, toward to the retracted position the awning canopy 202 is rolled onto the roll bar 206, causing the awning 202 to retract.

Further, the awning 202 retracts or extends in cooperation with the extension actuator 400 (various embodiments of the extension actuator will be discussed in greater detail below) associated with the respective first and second lateral arms 214, 216. The extension actuator 400 exerts a second force F2 to orient the awning 200 into an extended position, wherein the first force F1 is greater than the second force F2.

In one example embodiment, the powered actuator 500 (e.g., a motor, magnet, air compressor, spring, etc.) is coupled to the roll bar 206 and actuates the canopy 202 from the retracted position to the extended position. In another example embodiment, the powered actuator 500 is coupled to awning 100, 200 at various locations. In another example embodiment, a manual application of force, such as from the user, actuates the canopy 202 into the extended position.

In the following example embodiments, various combinations of the retraction actuator 300, extension actuator 400, and/or the powered actuator 500 are described in both the lateral and horizontal awnings 100, 200. It would be understood by one having ordinary skill in the art that any and all combinations of the retraction actuator 300, retraction actuator 400, and/or the powered actuator 500 and the lateral and horizontal awnings 100, 200 described herein are contemplated.

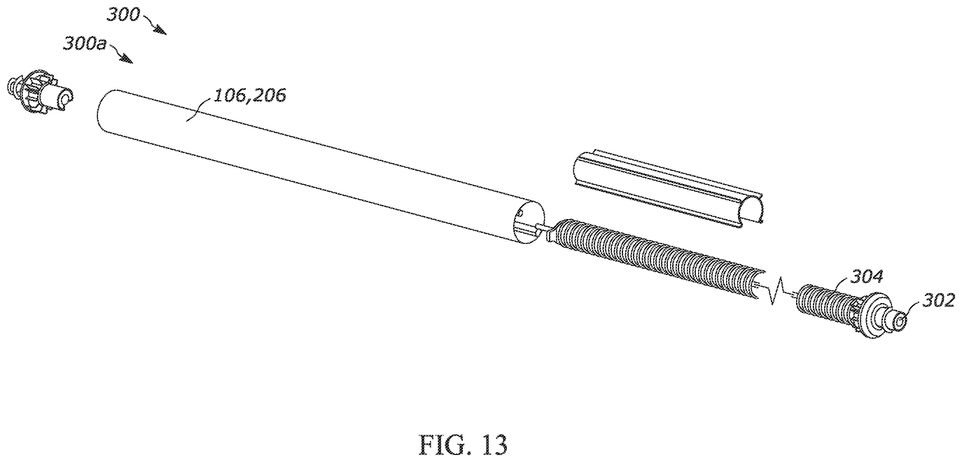

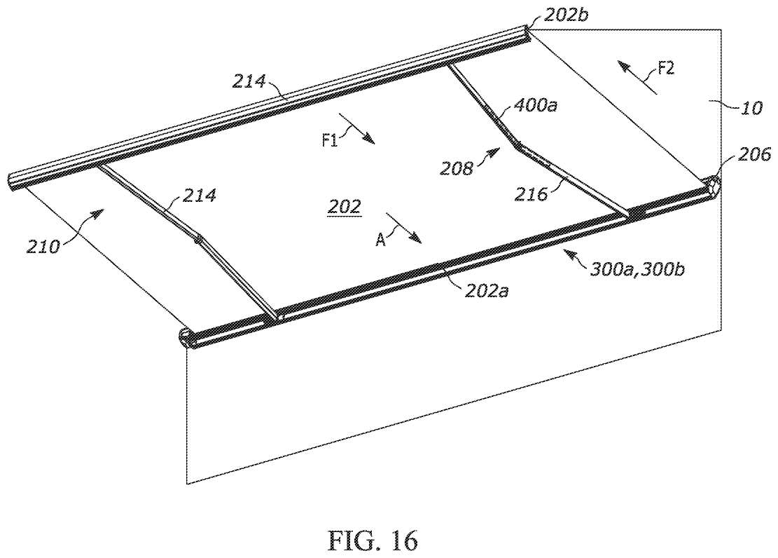

In the illustrated example embodiment of FIGS. 13 and 16, the retraction actuator 300 is a first retraction actuator comprising a torsion actuator 300a comprising a torsion spring 304 that resides in the roll bar 106, 206 of the awnings 100, 200. In this example embodiment, the torsion spring 304 is a mechanical spring that exerts torque or a twisting force responsive to the mechanical spring being twisted along an axis. The torsion spring 304 is coupled to a rotational end cap 302 of the roll bar 106, 206. As the awning 102, 202 is extended toward the extended position, the torsion spring 300a is wound as the load of extending is applied to the spring. The tension or force (e.g., F1) generated by the torsion spring 300a is in direction A toward retraction. In this example embodiment, the torsion actuator 300a generates the force F1 which is greater than the second force F2 provided by the extension actuator 400. When the awning 100, 200 is outside of the retracted position the torsion actuator 300a generates the force F1 which is greater than second force F2 provided by the extension actuator 400.

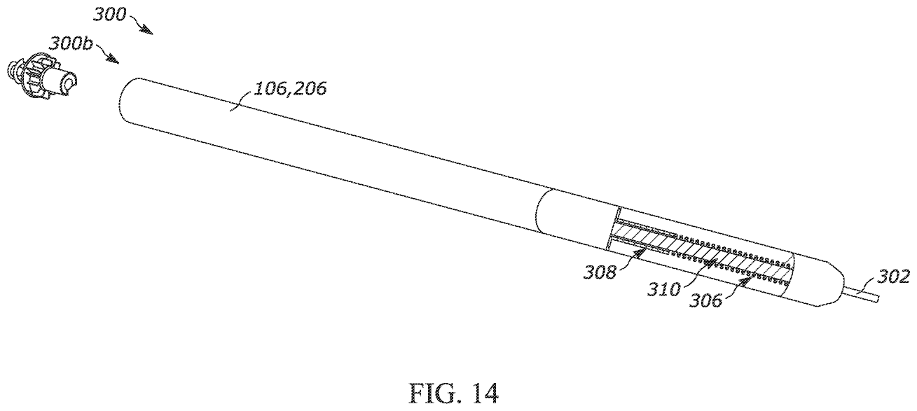

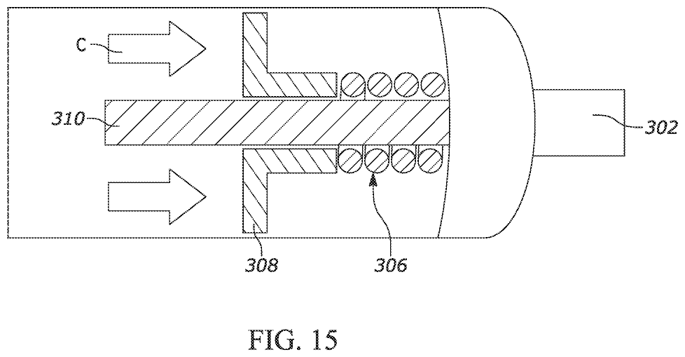

In the illustrated example embodiment of FIGS. 14-16, the retraction actuator 300 is a second retraction actuator comprising a compression actuator 300b. The compression actuator 300b comprises a compression spring 306 that resides in the roll bar 106, 206 of the awnings 100, 200. In this example embodiment, the compression spring 306 is a wound helical coil that is coupled to a nut 308 and is wrapped around a post 310, wherein the post provides a guide for the nut during compression. As the awning 102, 202 is extended toward the extended position, the compression spring 306 is compressed as the load of extending is applied to the compression spring 306. The tension or force (e.g., F1) generated by the compression spring 306 is in direction A toward retraction. As illustrated in FIG. 14, the compression spring 306 is un-compressed, and the awning 100, 200 is in the retracted position. When un-compressed, the compression spring 306 does not generate a force, or generates a minimal force. As illustrated in FIG. 15, the compression spring 306 is compressed, and the awning 100, 200 is in the extended position, wherein arrows C indicates the direction the nut 308 travels during extension of the awning 100, 200. When the awning 100, 200 is outside of the retracted position the compression spring 306 generates the force F1 which is greater than second force F2 provided by the extension actuator 400.

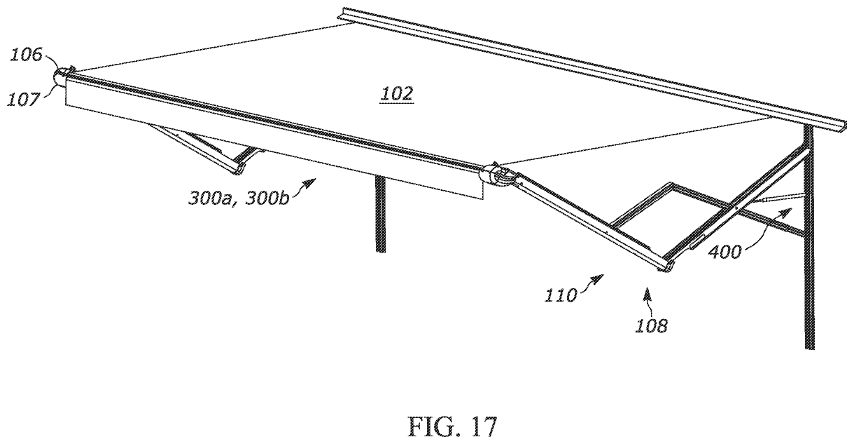

In FIG. 17, an idler 107 is present along with the retraction and extension actuators 300, 400. In this example embodiment, the idler 107 is functionally coupled to the roll bar 106, 206. In this example embodiment, the idler 107 guides the awning 100, 200 during retraction and extension. In one example embodiment, such as when the third force F3 is a manual force, the idler 107 includes or is coupled to a locking mechanism that locks the awning 100, 200 into the extended position once the combination of the second and third forces F2, F3 overcomes the first force F1. It would be understood that the idler 107 could be present on any of the awnings 100, 200 described herein.

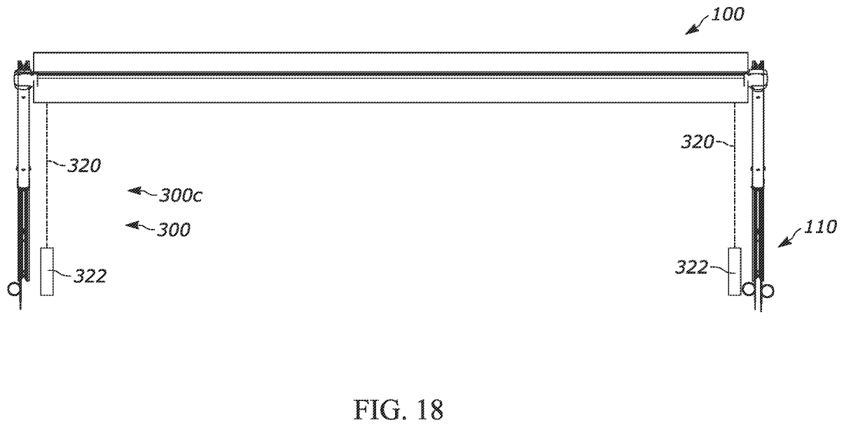

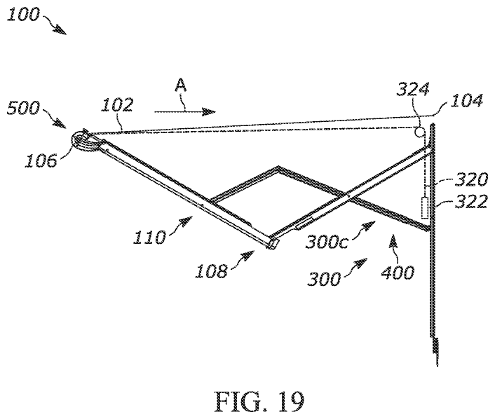

In the illustrated example embodiment of FIGS. 18-19, the retraction actuator 300 is third actuator, wherein the third actuation is a pulley-based actuator 300c comprising a cord or string 320 coupled to the roll bar 106. In this example embodiment, the cord or string 320 is coupled to a counterweight 322. In this example embodiment, a pivot point or directional pivot 324 is coupled to the awning 100 (e.g., the support rail 104, the support surface 10, etc.). As the awning 102 is extended toward the extended position (as illustrated in FIG. 19), the counterweight 322 is raised generating a weighted force based upon a weight of the counterweight. The tension or force (e.g., F1) generated by the counterweight is in direction A toward retraction. As illustrated in FIG. 18, the counterweight 322 is extended toward the ground or floor, and the awning 100 is in the retracted position. In one example embodiment, when the awning 100 is retracted, the counterweight 322 is generating a force, but as the awning 100 cannot mechanically retract anymore, the counterweight is static. As illustrated in FIG. 19, the counterweight 322 is raised and the awning 100 is in the extended position. The pulley-based actuator 300c having counterweight 322 generates the force F1 which is greater than second force F2 provided by the extension actuator 400. It would be understood by one having ordinary skill in the art that the weight is selected to provide the force F1 that is greater than the second force F2.

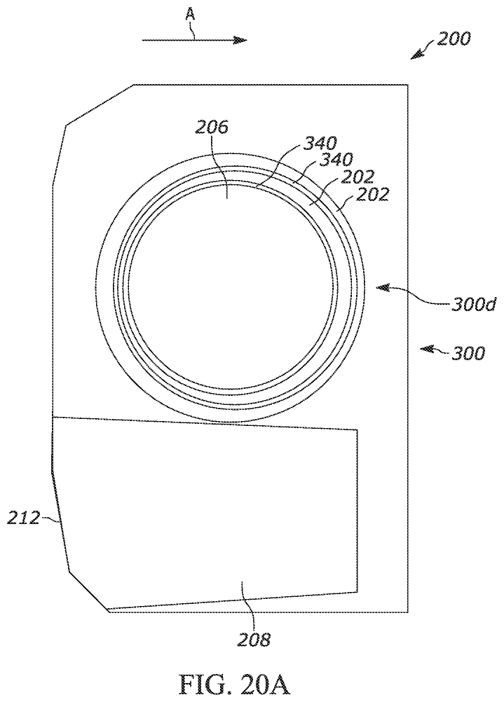

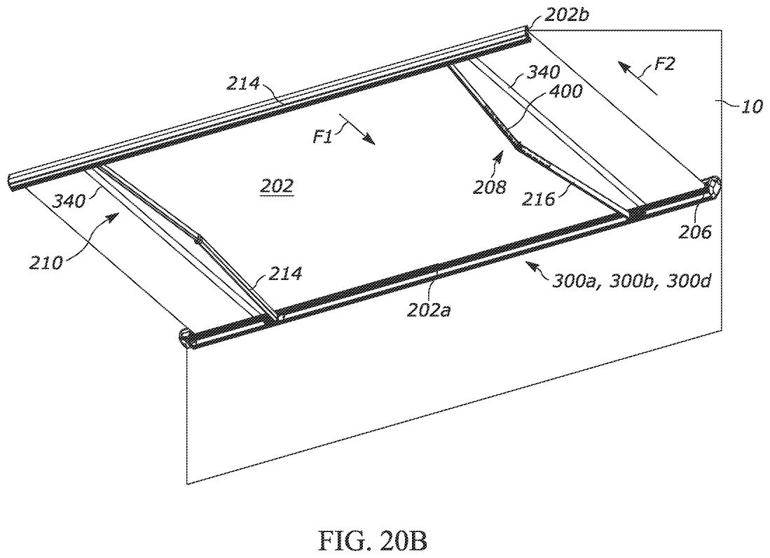

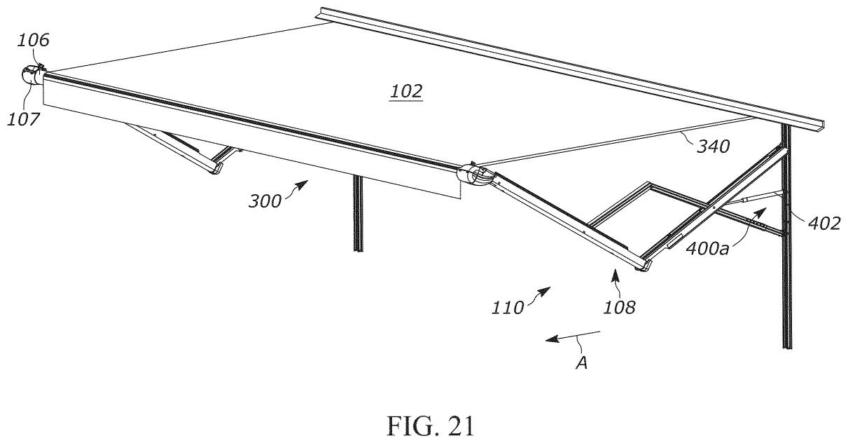

In the illustrated example embodiment of FIGS. 20A, 20B, and 21, the retraction actuator 300 is fourth actuator comprising a spring metal actuator 300d. The spring metal actuator 300d comprises a curved spring metal 340 coupled to the roll bar 106, 206 at a first end and the support rail 104, or the awning body 218 at a second end, respectively, the first end opposite the second end. In this embodiment, an integral spring (not shown) is coupled to the first end of the curved metal 340 within the roll bar 106, 206. Wherein when the awning 100, 200 is in the extended position, the integral spring coupled to the curved spring metal 340 is extended, and the curved spring metal 340 is extended from a rolled position and the force F1 is generate therefrom (e.g., as illustrated in FIGS. 20A, 21). As illustrated in FIGS. 20A, 21, when the curved spring metal 340 is extended, the awning 100, 200 is in the extended position. As illustrated in FIG. 20B, when the curved spring metal 340 is in the rolled position, the awning 100, 200 is in the retracted position, and the integral spring is compressed, thus generating little to no force. The tension or force (e.g., F1) generated by the curved spring metal 340 is in direction A toward retraction. When the awning 100, 200 is outside of the retracted position the curved spring metal 340 generates the force F1 which is greater than the second force F2 provided by the extension actuator 400.

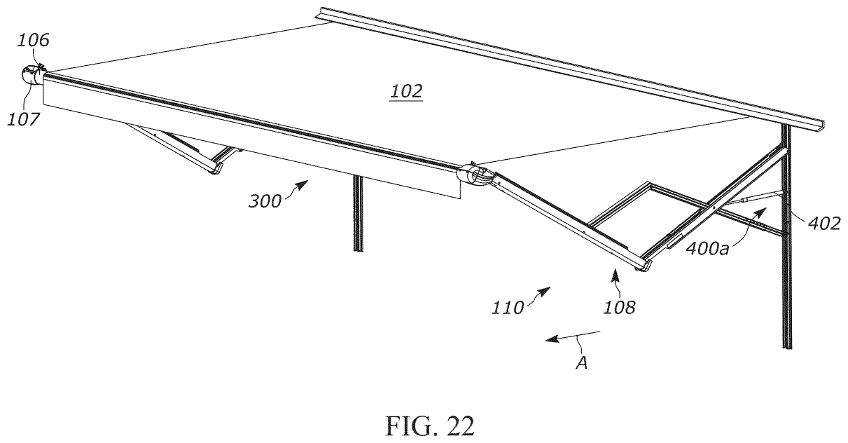

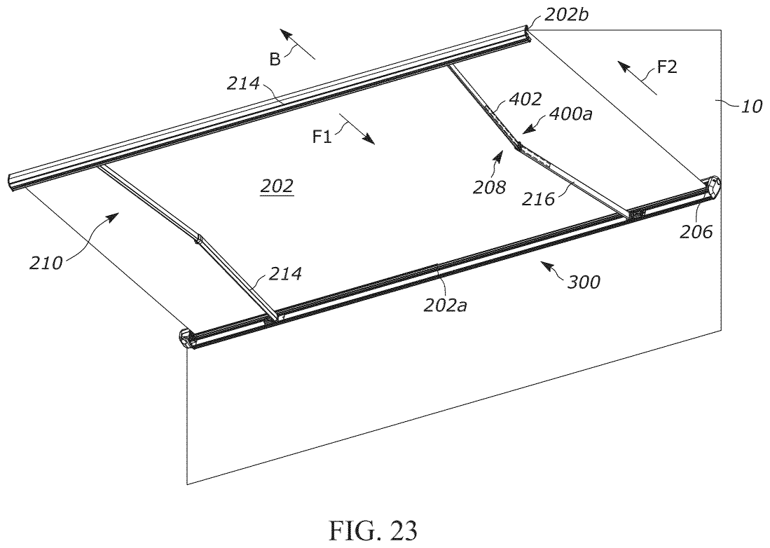

As illustrated in FIGS. 22 and 23, the extension actuator 400 is a biased actuator 400a comprising a gas spring or compression spring 402. In one example embodiment, the gas spring or compression spring 402 is coupled to a portion of the support system 108, 208. In another example embodiment, the compression spring 402 is coupled to a portion of the support system 108 of the horizontal awning 100. In yet another example embodiment, the compression spring 402 is contained within one or more of the lateral arms 214, 216 of the lateral awning 200. In one example embodiment, such as on the awning 100 illustrated in FIG. 22, the gas spring 402 is coupled the track 112 and the support pin 114. In another example embodiment, such as on the awning 200 as illustrated in FIG. 23, the compression spring 402 is coupled to one or both of the lateral arms 214, 216. In another example embodiment, the compression spring 402 is coupled to and inside the distal arm and the proximal arm of one or both of the lateral arms 214, 216. Wherein responsive to the awning 100, 200 being in the extended position, the gas or compression spring 402 is extended, and when the awning is in the retracted position, the gas or compression spring 402 is in a retracted position. The tension or force (e.g., F2) generated by the gas or compression spring 402 is in direction B toward extension. When the awning 100, 200 is in the retracted position and/or the extended position the gas or compression spring 402 generates the force F2 which is less than first force F1 provided by the retraction actuator 300. It would be understood by one having ordinary skill in the art, that the linear actuator 402 can be used with any of the retraction actuators 300a-300d described herein. Further it would be understood, that the retraction actuator 300 refers to any of the retraction actuators 300a-300d unless otherwise specified.

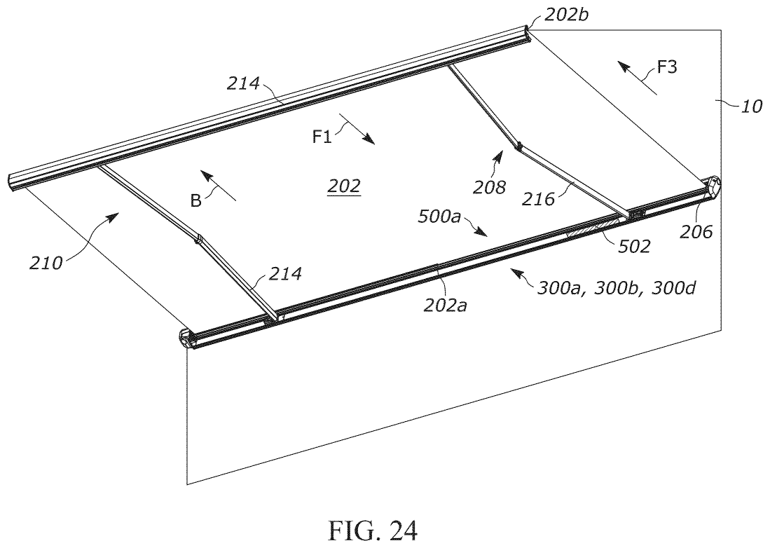

In the illustrated example embodiment of FIGS. 24-32, the powered actuator 500 is illustrated. In the illustrated example embodiment of FIG. 24, the powered actuator 500 is a first motor 500a that comprises an electric or hydraulic motor 502 that resides in awning body 218 of the awning 200. In this example embodiment, wherein the electric or hydraulic motor 502 of the awning 200 extends the first and second lateral arms 214, 216 coupled to the roll bar 206 into the extended position. In this example embodiment, the tension or force (e.g., F3) generated by the electric or hydraulic motor 502 is in direction B toward extension. In this example embodiment, wherein no retraction element 400 is present, the third force F3 of the electric or hydraulic motor 502 is greater than the first force F1 of the retraction actuator 300, wherein should the electric or hydraulic motor 502 fail, it will cease generating the third force, and the awning 200 will retract. In another example embodiment, wherein the retraction element 400 is present, the third force F3 of the electric or hydraulic motor 502 is less than the first force F1 of the retraction actuator 300, however, the combined second and third forces F2 and F3 of the extension actuator 400 and the electric or hydraulic motor 502 are greater than first force F1, wherein should the electric or hydraulic motor 502 fail, it will cease generating force, and the awning 200 will retract.

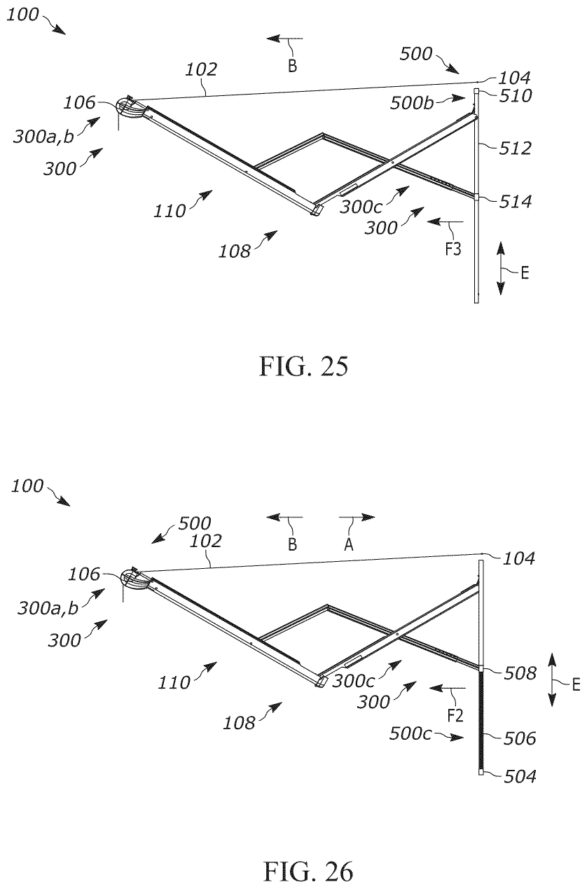

In the illustrated example embodiment of FIG. 25, the powered actuator 500 is a second motor actuator 500b comprising an electric or hydraulic motor 510 that is located along or within the track 112 of the awning 200. In this example embodiment, the motor 510 is located at a location above the scissor arm 110 connection locations. In this example embodiment, the motor 510 is coupled to the slideable pin 130 which allows for translation of the first supplemental member 118 about and within the vertical track 112 in the directions of arrows E. In this example embodiment, the motor 510 lifts the first supplemental member 118 causing the awning 100 to extend into the extended position. In this example embodiment, the tension or force (e.g., F3) generated by the motor 510 is in direction B toward extension.

In this example embodiment, wherein no extension element 400 is present, the third force F3 of the motor 510 is greater than the first force F1 of the retraction actuator 300, wherein should the motor 510 fail, it will cease generating force, and the awning 100 will retract. In another example embodiment, wherein the extension element 400 is present, the third force F3 of the motor 510 is less than the first force F1 of the retraction actuator 300, however, the combined second and third forces F2 and F3 of the extension actuator 400 and the motor 510 are greater than the first force F1, wherein should the motor 510 fail, it will cease generating force, and the awning 100 will retract.

In the illustrated example embodiment of FIG. 26, the powered actuator 500 is a third motor actuator 500c that comprises an electric or hydraulic motor 504 coupled to a screw rod 506 located along or within the track 112 of the awning 100. In this example embodiment, the motor 510 is located at a location below the scissor arm 110 connection locations. In this example embodiment, the motor 504 is coupled to the slideable pin 130 via a rotation member 508 (e.g., a nut) which allows for translation of the first supplemental member 118 about and within the vertical track 112 in the directions of arrows E. Wherein when the motor 504 rotates in one of a clockwise or a counterclockwise direction the awning 100 extends, and when the motor rotates in the other of a clockwise or counterclockwise direction the awning retracts. In this example embodiment, the motor 504 lifts the first supplemental member 118 causing the awning 100 to extend into the extended position. In this example embodiment, the tension or force (e.g., F3) generated by the motor 504 can be either in direction B toward extension or direction A toward retraction.

In the illustrated example embodiment of FIG. 26, wherein no extension element 400 is present, the third force F3 of the motor 504 is greater than the first force F1 of the retraction actuator 300, wherein should the motor 504 fail, it will cease generating force, and the awning 100 will retract. In another example embodiment, wherein the extension element 400 is present, the third force F3 of the motor 504 is less than the first force F1 of the retraction actuator 300, however, the combined second and third forces F2 and F3 of the extension actuator 400 and the motor 504 are greater than the first force F1, wherein should the motor 504 fail, it will cease generating force, and the awning 100 will retract.

In the illustrated example embodiment of FIG. 27, the powered actuator 500 is a fourth motor actuator 500d that comprises an electric or hydraulic motor 516 coupled to a horizontal awning 100a having first and second single body extension arms 110a that couple to the track 112 at a first end or near the first end of the track, wherein the awning 102 is coupled to a second end or near the second end of the track. In this example embodiment, motor 516 is located at a location where at least one of the arms 110a is coupled to the track 112. In this example embodiment, the motor 516 extend the first and second arms 110a away from the track 112 causing the awning 100a to extend into the extended position. In this example embodiment, the tension or force (e.g., F3) generated by the motor 516 can be either in direction B toward extension or direction A toward retraction.

In the illustrated example embodiment of FIG. 27, wherein no extension element 400 is present, the third force F3 of the motor 516 is greater than the first force F1 of the retraction actuator 300, wherein should the motor 516 fail, it will cease generating force, and the awning 100 will retract. In another example embodiment, wherein the extension element 400 is present, the third force F3 of the motor 516 is less than the first force F1 of the retraction actuator 300, however, the combined second and third forces F2 and F3 of the extension actuator 400 and the motor 516 are greater than the first force F1, wherein should the motor 516 fail, it will cease generating force, and the awning 100 will retract.

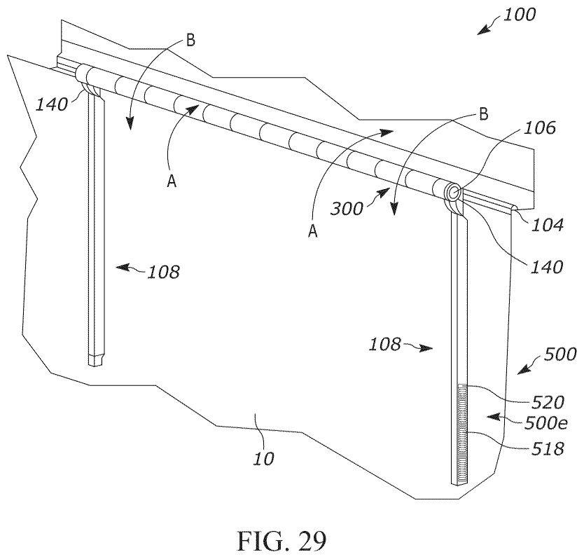

In the illustrated example embodiment of FIGS. 28-29, the powered actuator 500 is a magnet actuator 500e that comprises one or more electro magnets 518 and one or more neodymium magnets 520 located along or within the track 112 of the awning 100. In one example embodiment, the one or more neodymium magnets 520 are located in the first supplemental member 118. In another example embodiment, the one or more neodymium magnets 520 are coupled to the first supplemental member 118. In this example embodiment, a series of the one or more electro magnets 518 are located at a location below the scissor arm 110 connection locations. In this example embodiment, the one or more neodymium magnets 520 being within or coupled to the first supplemental member 118 allows for translation of the first supplemental member 118 about and within the vertical track 112 in the directions of arrows E. Wherein responsive to being energized, the series of the one or more electromagnets 518 separate or space from one another causing the awning 100 to extend. In this example embodiment, the electrified series of the one or more electromagnets 518 lifts the first supplemental member 118 via the one or more neodymium magnets 520 the causing the awning 100 to extend into the extended position. In this example embodiment, the tension or force (e.g., F3) generated by the one or more electro magnets 518 is in direction B toward extension.

In the illustrated example embodiment of FIGS. 28-29, wherein no extension element 400 is present, the third force F3 generated by the electrification of the one or more electro magnets 518 is greater than the first force F1 of the retraction actuator 300, wherein should the electrification of the one or more electro magnets 518 fail and/or the magnets themselves fail, it will cease generating force, and the awning 100 will retract. In another example embodiment, wherein the extension element 400 is present, the third force F3 generated by the electrification of the one or more electro magnets 518 is less than the first force F1 of the retraction actuator 300, however, the combined second and third forces F2 and F3 of the extension actuator 400 and the electrification of the one or more electro magnets 518 are greater than the first force F1, wherein should the electrification of the one or more electro magnets 518 fail, the magnet actuator 500e will cease generating force, and the awning 100 will retract. It would be understood by those having ordinary skill in the art, that one or more of the motors 500a-500e, could be present in one of the first and second arms 108, 214, 216, the roll bar 106, 206, or an endcap coupled to the roll bar.

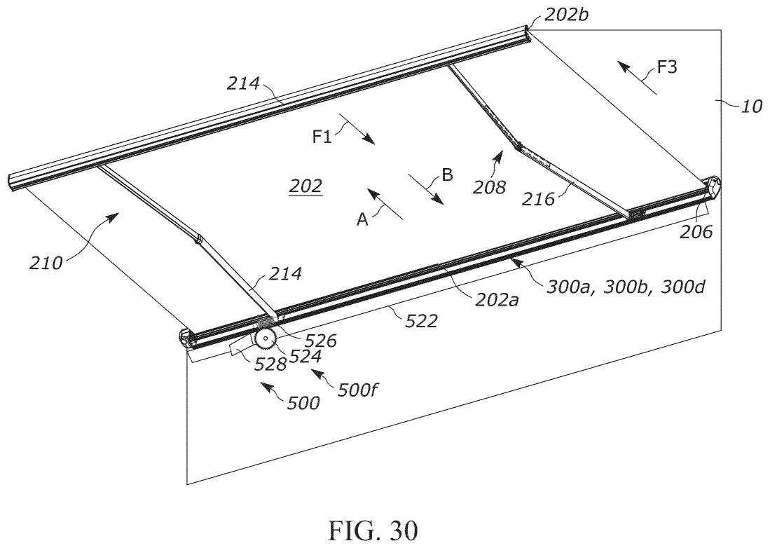

In the illustrated example embodiment of FIG. 30, the powered actuator 500 is a worm gear actuator 500f that comprises an electric or hydraulic motor 528 coupled to a worm wheel 524. The worm wheel 524 is coupled to a worm 526 that interacts with one of the first or second lateral arms 214, 216. The electric or hydraulic motor 528 applies rotational power via the worm wheel 524 to the worm 526, wherein the rotation of the worm 526 causes the awning 200 to retract or extend. In this embodiment, the worm 526 rotates against the wheel 524, and a screw face of the worm 526 pushes on teeth of the worm wheel 524, wherein the screw face of the worm also interacts with the first or second lateral arms 214, 216 to extend or retract the arms. In this example embodiment, the worm gear actuator 500f is discrete from the roll bar 206, and/or the awning body 218. Wherein the motor 528 rotates the worm wheel 524 in one of a clockwise or counterclockwise direction the awning 200 extends, and when the motor 528 rotates the worm wheel 524 in the other of a clockwise or counterclockwise direction the awning retracts. In this example embodiment, the tension or force (e.g., F3) generated by the motor 528 can be either in direction B toward extension or direction A toward retraction.

In the illustrated example embodiment of FIG. 30, wherein no extension element 400 is present, the third force F3 of the motor 528 is greater than the first force F1 of the retraction actuator 300, wherein should the motor 528 fail, it will cease generating force, and the awning 200 will retract. In another example embodiment, wherein the extension element 400 is present, the third force F3 of the motor 528 is less than the first force F1 of the retraction actuator 300, however, the combined second and third forces F2 and F3 of the extension actuator 400 and the motor 528 are greater than the first force F1, wherein should the motor 528 fail, the worm gear actuator 500f will cease generating force, and the awning 100 will retract.

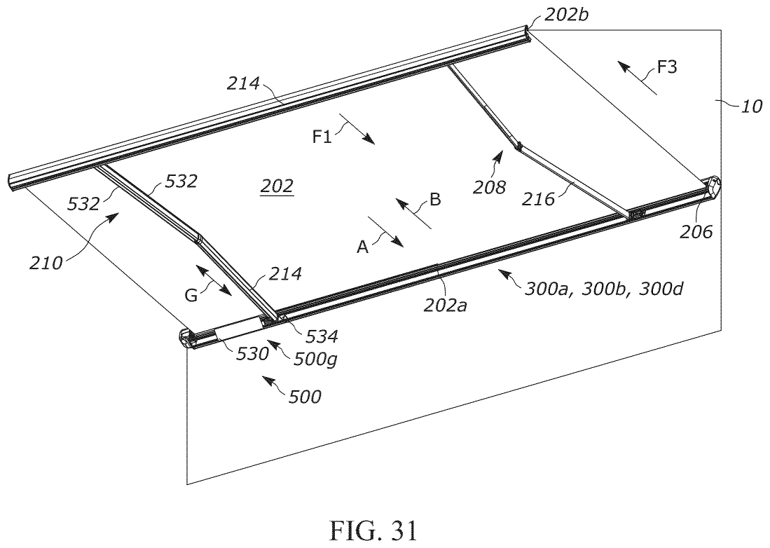

In the illustrated example embodiment of FIG. 31, the powered actuator 500 is a motor driven arm cable 500g that comprises an electric or hydraulic motor 530 coupled to a cable 532. In this example embodiment, the motor 530 is located within the awning body 218. In one example embodiment, the cable 532 is coupled to and around at least one of the first or second lateral arms 214, 216 (e.g, the cable extends along a first side of the lateral arm toward the lead rail, interacts with the lead rail 214, and extends back toward the awning body 218, and couples to itself or the motor 530). In one example embodiment, the motor 530 retracts the cable 532 (e.g., causing the cable to shorten) causing the awning 200 to extend. In another example embodiment, the motor 530 extends the cable 532 allowing the cable to lengthen, thus allowing the awning 200 to retract. In this example embodiment, the tension or force (e.g., F3) generated by the motor 530 is in direction B toward extension.

In the illustrated example embodiment of FIG. 30, wherein no extension element 400 is present, the third force F3 of the motor 530 is greater than the first force F1 of the retraction actuator 300, wherein should the motor 530 fail, it will cease generating force, and the awning 200 will retract. In another example embodiment, wherein the extension element 400 is present, the third force F3 of the motor 530 is less than the first force F1 of the retraction actuator 300, however, the combined second and third forces F2 and F3 of the extension actuator 400 and the motor 530 are greater than force F1, wherein should the motor 530 fail, the motor driven arm cable 500g will cease generating force, and the awning 100 will retract.

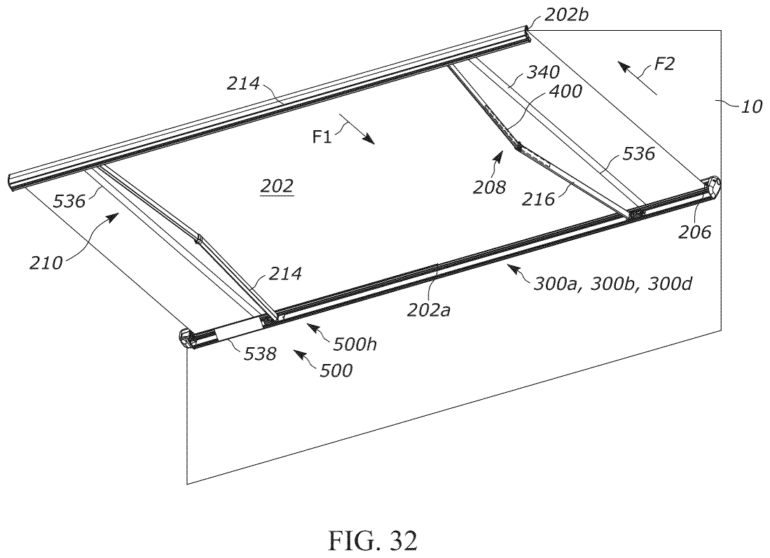

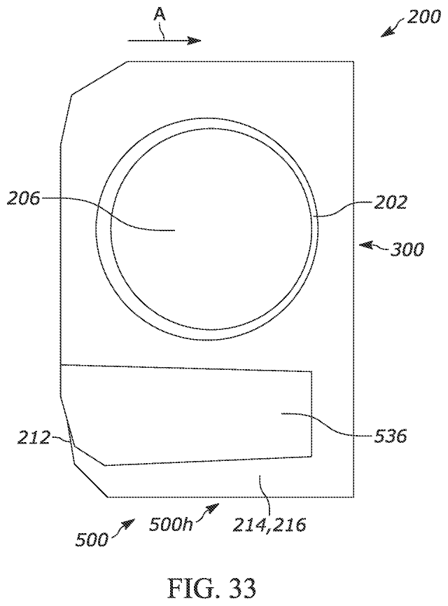

In the illustrated example embodiment of FIGS. 32-33, the powered actuator 500 is a compressor driven bladder 500h that comprises an air compressor 538 fluidly coupled to one or more air bladders 536. In this example embodiment, the air compressor 538 is located within the awning body 218. In another example embodiment, the air compressor 538 is a separate structure from the awning body 218. In one example embodiment, the one or more air bladders 536 are coupled to and around at least one of the first or second lateral arms 214, 216. In another example embodiment, the one or more air bladders 536 are coupled to the lead rail 214. In one example embodiment, such as when first and second air bladders 536 are present, one or two air compressors 538 are present. The air compressor 538 provides air pressure to the one or more air bladders 536 causing the awning 200 to extend, and extends the one or more air bladders 536 as additional air pressure enters into the bladders. Once a threshold pressure is reached, the air compressors 538 cease adding additional air (e.g., once the bladders have fully extended the awning 200). In another example embodiment, responsive to the air compressor 538 releasing air from one or more air bladders 536 the awning 200 will be allowed to retract. In this example embodiment, the tension or force (e.g., F3) generated by the air compressor 538 is in direction B toward extension.

In the illustrated example embodiment of FIGS. 32-33, wherein no extension element 400 is present, the third force F3 of the air compressor 538 is greater than the first force F1 of the retraction actuator 300, wherein should the air compressor 538 fail or the one or more bladders 536 leak, it will cease generating force, and the awning 200 will retract (as illustrated in FIG. 33). In another example embodiment, wherein the extension element 400 is present, the third force F3 of the air compressor 538 is less than the first force F1 of the retraction actuator 300, however, the combined second and third forces F2 and F3 of the extension actuator 400 and the air compressor 538 are greater than the first force F1, wherein should the air compressor 538 fail or the one or more bladders 536 leak, the compressor driven bladder 500h will cease generating force, and the awning 200 will retract.

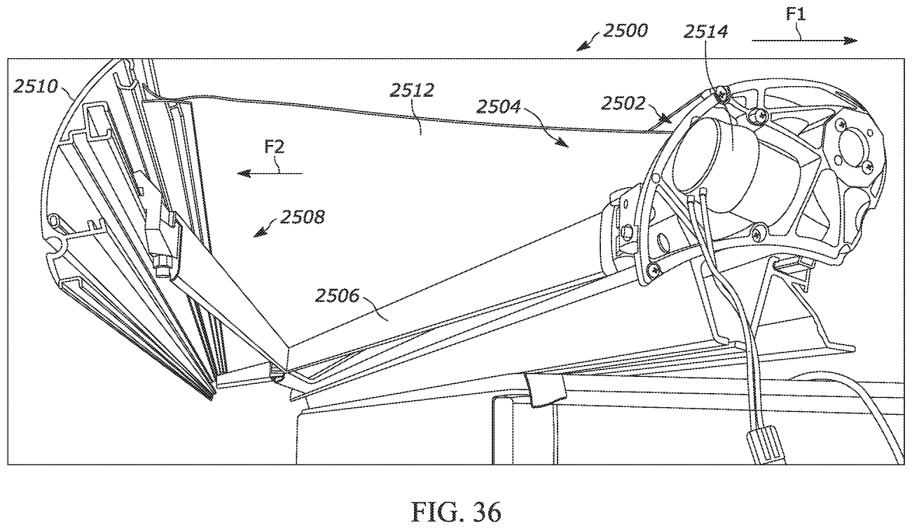

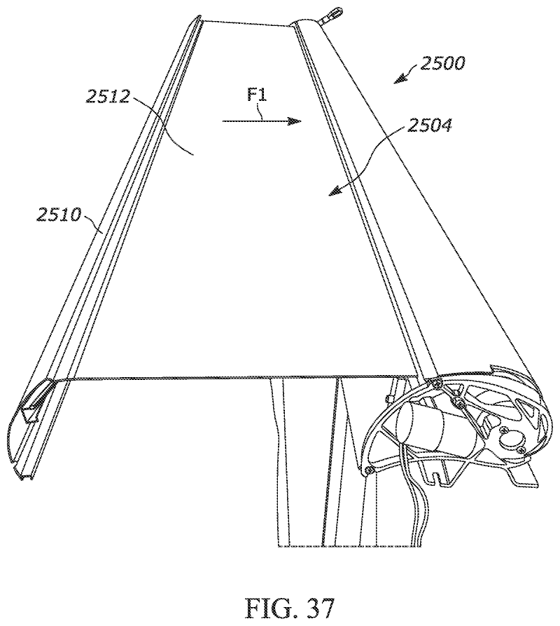

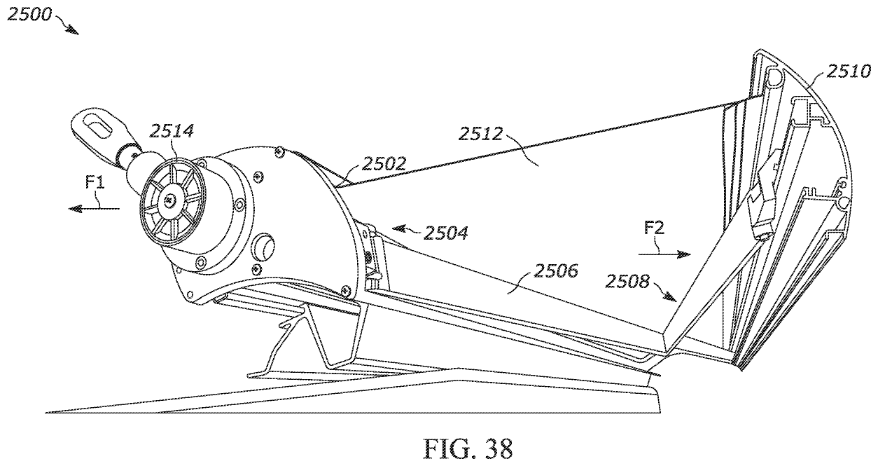

FIGS. 33-37 illustrate an awning 2500 that comprises the first force F1 originating from an actuator 2504 (e.g., a tension spring, or any other actuator described herein). In this example embodiment, the actuator 2504 is housed within or in communication with a roll bar 2502 that supports an awning canopy 2512. The actuator 2504 exerts the first force F1 to orient the awning 2500 into a retracted position. In this example embodiment, the roll bar 2502 is coupled to one or more arms 2506. It would be understood by one of ordinary skill in the art that the arms 2506 are one of horizontal or vertical arms. The one or more arms 2506 are coupled to a lead rail 2510. The lead rails 2510 is coupled to a first end of the awning canopy 2512, wherein the roll bar 2502 is coupled to a second end of the awning canopy, the first end opposite the second end. A second actuator 2508 (e.g., a spring, a linear actuator having a physical, fluid, electrical, and/or magnetic force, and/or any other actuator described herein) exerts a second force F2 to orient the awning 2500 into an extended position, wherein the first force F1 is greater than the second force F2. The awning 2500 supports a motor 2514 that applies a third force to extend the awning 2500 into the extended position. The sum of the second force F2 and the third force are greater than the first force F1.

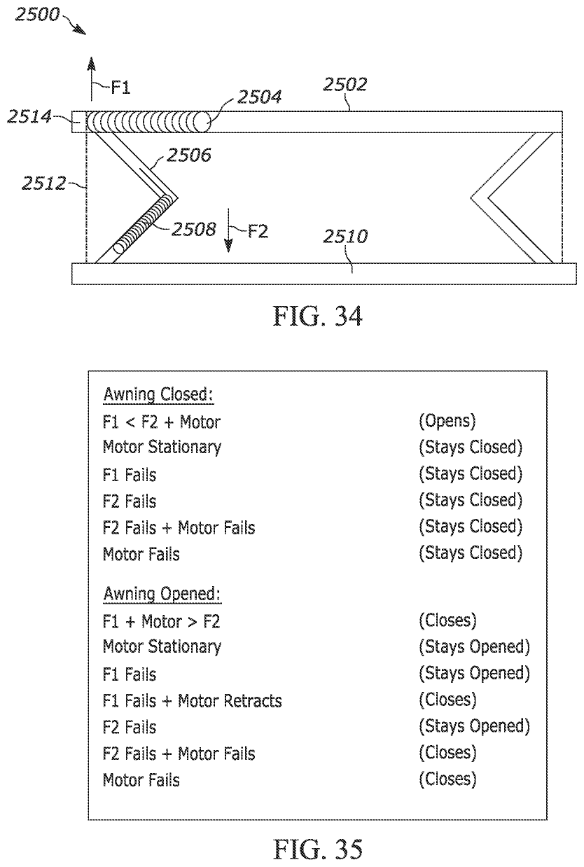

As shown in the example embodiment illustrated in FIG. 34, when the motor 2514 is active, the combined force of the third and second force F2 extends or opens the awning 2500. Wherein, responsive to one of the motor 2514 being stationary, the first actuator 2504 failing, the second actuator 2508 failing, the second actuator and the motor 2514 failing, and/or the motor failing, the awning 2500 stays in or reverts to the retracted position. Further, wherein responsive to one of the first force F1 and the third force (e.g., the motor 2514 working in a reverse direction to retract the awning 2500) being greater than the second force F2, the first actuator 2508 failing and the motor working in the reverse direction, the second actuator 2504 failing and the motor failing, and/or the motor failing, the awning 2500 stays in or reverts to the retracted position. In another example embodiment, responsive to one of the motor 2514 being stationary, the first actuator 2504 failing, and/or the second actuator 2508 failing, the awning 2500 stays in the extended position. Further it would be understood that the various awnings function as vertical and/or horizontal awnings.

In one example embodiment, the awning 100 includes the torsion actuator 300a and the compression spring 402. In one example embodiment, the awning 100 includes the torsion actuator 300a, the compression spring 402, and the first motor actuator 500a. In one example embodiment, the awning 100 includes the torsion actuator 300a, the compression spring 402, and the second motor actuator 500b. In one example embodiment, the awning 100 includes the torsion actuator 300a, the compression spring 402, and the third motor actuator 500c. In one example embodiment, the awning 100 includes the torsion actuator 300a, the compression spring 402, and the fourth motor actuator 500d. In one example embodiment, the awning 100 includes the torsion actuator 300a, the compression spring 402, and the magnet actuator 500e. In one example embodiment, the awning 100 includes the torsion actuator 300a, the compression spring 402, and the worm gear actuator 500f. In one example embodiment, the awning 100 includes the torsion actuator 300a, the compression spring 402, and the motor driven arm cable 500g. In one example embodiment, the awning 100 includes the torsion actuator 300a, the compression spring 402, and the compressor driven bladder 500h. In one example embodiment, the awning 100 includes the torsion actuator 300a and the compression spring 402. In one example embodiment, the awning 100 includes the torsion actuator 300a and the first motor actuator 500a, wherein no compression spring 402 is present. In one example embodiment, the awning 100 includes the torsion actuator 300a and the second motor actuator 500b, wherein no compression spring 402 is present. In one example embodiment, the awning 100 includes the torsion actuator 300a and the third motor actuator 500c, wherein no compression spring 402 is present. In one example embodiment, the awning 100 includes the torsion actuator 300a and the fourth motor actuator 500d, wherein no compression spring 402 is present. In one example embodiment, the awning 100 includes the torsion actuator 300a and the magnet actuator 500e, wherein no compression spring 402 is present. In one example embodiment, the awning 100 includes the torsion actuator 300a and the worm gear actuator 500f, wherein no compression spring 402 is present. In one example embodiment, the awning 100 includes the torsion actuator 300a and the motor driven arm cable 500g, wherein no compression spring 402 is present. In one example embodiment, the awning 100 includes the torsion actuator 300a and the compressor driven bladder 500h, wherein no compression spring 402 is present.

In one example embodiment, the awning 100 includes the compression actuator 300b and the compression spring 402. In one example embodiment, the awning 100 includes the compression actuator 300b, the compression spring 402, and the first motor actuator 500a. In one example embodiment, the awning 100 includes the compression actuator 300b, the compression spring 402, and the second motor actuator 500b. In one example embodiment, the awning 100 includes the compression actuator 300b, the compression spring 402, and the third motor actuator 500c. In one example embodiment, the awning 100 includes the compression actuator 300b, the compression spring 402, and the fourth motor actuator 500d. In one example embodiment, the awning 100 includes the compression actuator 300b, the compression spring 402, and the magnet actuator 500e. In one example embodiment, the awning 100 includes the compression actuator 300b, the compression spring 402, and the worm gear actuator 500f. In one example embodiment, the awning 100 includes the compression actuator 300b, the compression spring 402, and the motor driven arm cable 500g. In one example embodiment, the awning 100 includes the compression actuator 300b, the compression spring 402, and the compressor driven bladder 500h. In one example embodiment, the awning 100 includes the compression actuator 300b and the compression spring 402. In one example embodiment, the awning 100 includes the compression actuator 300b and the first motor actuator 500a, wherein no compression spring 402 is present. In one example embodiment, the awning 100 includes the compression actuator 300b and the second motor actuator 500b, wherein no compression spring 402 is present. In one example embodiment, the awning 100 includes the compression actuator 300b and the third motor actuator 500c, wherein no compression spring 402 is present. In one example embodiment, the awning 100 includes the compression actuator 300b and the fourth motor actuator 500d, wherein no compression spring 402 is present. In one example embodiment, the awning 100 includes the compression actuator 300b and the magnet actuator 500e, wherein no compression spring 402 is present. In one example embodiment, the awning 100 includes the compression actuator 300b and the worm gear actuator 500f, wherein no compression spring 402 is present. In one example embodiment, the awning 100 includes the compression actuator 300b and the motor driven arm cable 500g, wherein no compression spring 402 is present. In one example embodiment, the awning 100 includes the compression actuator 300b and the compressor driven bladder 500h, wherein no compression spring 402 is present.

In one example embodiment, the awning 100 includes the pulley-based actuator 300c and the compression spring 402. In one example embodiment, the awning 100 includes the pulley-based actuator 300c, the compression spring 402, and the first motor actuator 500a. In one example embodiment, the awning 100 includes the pulley-based actuator 300c, the compression spring 402, and the second motor actuator 500b. In one example embodiment, the awning 100 includes the pulley-based actuator 300c, the compression spring 402, and the third motor actuator 500c. In one example embodiment, the awning 100 includes the pulley-based actuator 300c, the compression spring 402, and the fourth motor actuator 500d. In one example embodiment, the awning 100 includes the pulley-based actuator 300c, the compression spring 402, and the magnet actuator 500e. In one example embodiment, the awning 100 includes the pulley-based actuator 300c, the compression spring 402, and the worm gear actuator 500f. In one example embodiment, the awning 100 includes the pulley-based actuator 300c, the compression spring 402, and the motor driven arm cable 500g. In one example embodiment, the awning 100 includes the pulley-based actuator 300c, the compression spring 402, and the compressor driven bladder 500h. In one example embodiment, the awning 100 includes the pulley-based actuator 300c and the compression spring 402. In one example embodiment, the awning 100 includes the pulley-based actuator 300c and the first motor actuator 500a, wherein no compression spring 402 is present. In one example embodiment, the awning 100 includes the pulley sed actuator 300c and the second motor actuator 500b, wherein no compression spring 402 is present. In one example embodiment, the awning 100 include the pulley-based actuator 300c and the third motor actuator 500c, wherein no compression ring 402 is present. In one example embodiment, the awning 100 includes the pulley-based actuator 300c and the fourth motor actuator 500d, wherein no compression spring 402 is present. In one example embodiment, the awning 100 includes the pulley-based actuator 300c and the magnet actuator 500e, wherein no compression spring 402 is present. In one example embodiment, the awning 100 includes the pulley-based actuator 300c and the worm gear actuator 500f, wherein no compression spring 402 is present. In one example embodiment, the awning 100 includes the pulley-based actuator 300c and the motor driven arm cable 500g, wherein no compression spring 402 is present. In one example embodiment, the awning 100 includes the pull-based actuator 300c and the compressor driven bladder 500h, wherein no compression 402 is present.

In one example embodiment, the awning 100 includes the spring metal actuator 300d and the compression spring 402. In one example embodiment, the awning 100 includes the spring metal actuator 300d, the compression spring 402, and the first motor actuator 500a. In one example embodiment, the awning 100 includes the spring metal actuator 300d, the compression spring 402, and the second motor actuator 500b. In one example embodiment, the awning 100 includes the spring metal actuator 300d, the compression spring 402, and the third motor actuator 500c. In one example embodiment, the awning 100 includes the spring metal actuator 300d, the compression spring 402, and the fourth motor actuator 500d. In one example embodiment, the awning 100 includes the spring metal actuator 300d, the compression spring 402, and the magnet actuator 500e. In one example embodiment, the awning 100 includes the spring metal actuator 300d, the compression spring 402, and the worm gear 500f. In one example embodiment, the awning 100 includes the spring metal actuator 300d, the compression spring 402, and the motor driven arm cable 500g. In one example embodiment, the awning 100 includes the spring metal actuator 300d, the compression spring 402, and the compressor driven bladder 500h. In one example embodiment, the awning 100 includes the spring metal actuator 300d and the compression spring 402. In one example embodiment, the awning 100 includes the spring metal actuator 300d and the first motor actuator 500a, wherein no compression spring 402 is present. In one example embodiment, the awning 100 includes the spring metal actuator 300d and the second motor actuator 500b, wherein no compression 402 is present. In one example embodiment, the awning 100 includes the spring metal actuator 300d and the third motor actuator 500c, wherein no compression spring 402 is present. In one example embodiment, the awning 100 includes the spring metal actuator 300d and the fourth motor actuator 500d, wherein no compression spring 402 is present. In one example embodiment, the awning 100 includes the spring metal actuator 300d and the magnet actuator 500e, wherein no compression spring 402 is present. In one example embodiment, the awning 100 includes the spring metal actuator 300d and the worm gear actuator 500f, wherein no compression spring 402 is present. In one example embodiment, the awning 100 includes the spring metal actuator 300d and the motor driven arm cable 500g, wherein no compression spring 402 is present. In one example embodiment, the awning 100 includes the spring metal actuator 300d and the compressor driven bladder 500h, wherein no compression spring 402 is present.

In one example embodiment, the awning 200 includes the torsion actuator 300a and the gas spring 402. In one example embodiment, the awning 200 includes the torsion actuator 300a, the gas spring 402, and the first motor actuator 500a. In one example embodiment, the awning 200 includes the torsion actuator 300a, the gas spring 402, and the second motor actuator 500b. In one example embodiment, the awning 200 includes the torsion actuator 300a, the gas spring 402, and the third motor actuator 500c. In one example embodiment, the awning 200 includes the torsion actuator 300a, the gas spring 402, and the fourth motor actuator 500d. In one example embodiment, the awning 200 includes the torsion actuator 300a, the gas spring 402, and the magnet actuator 500e. In one example embodiment, the awning 200 includes the torsion actuator 300a, the gas spring 402, and the worm gear actuator 500f. In one example embodiment, the awning 200 includes the torsion actuator 300a, the gas spring 402, and the motor driven arm cable 500g. In one example embodiment, the awning 200 includes the torsion actuator 300a, the gas spring 402, and the compressor driven bladder 500h. In one example embodiment, the awning 200 includes the torsion actuator 300a and the gas spring 402. In one example embodiment, the awning 200 includes the torsion actuator 300a and the first motor actuator 500a, wherein no gas spring 402 is present. In one example embodiment, the awning 200 includes the torsion actuator 300a and the second motor actuator 500b, wherein no gas spring 402 is present. In one example embodiment, the awning 200 includes the torsion actuator 300a and the third motor actuator 500c, wherein no gas spring 402 is present. In one example embodiment, the awning 200 includes the torsion actuator 300a and the fourth motor actuator 500d, wherein no gas spring 402 is present. In one example embodiment, the awning 200 includes the torsion actuator 300a and the magnet actuator 500e, wherein no gas spring 402 is present. In one example embodiment, the awning 200 includes the torsion actuator 300a and the worm gear actuator 500f, wherein no gas spring 402 is present. In one example embodiment, the awning 200 includes the torsion actuator 300a and the motor driven arm cable 500g, wherein no gas spring 402 is present. In one example embodiment, the awning 200 includes the torsion actuator 300a and the compressor driven bladder 500h, wherein no gas spring 402 is present.

In one example embodiment, the awning 200 includes the compression actuator 300b and the gas spring 402. In one example embodiment, the awning 200 includes the compression actuator 300b, the gas spring 402, and the first motor actuator 500a. In one example embodiment, the awning 200 includes the compression actuator 300b, the gas spring 402, and the second motor actuator 500b. In one example embodiment, the awning 200 includes the compression actuator 300b, the gas spring 402, and the third motor actuator 500c. In one example embodiment, the awning 200 includes the compression actuator 300b, the gas spring 402, and the fourth motor actuator 500d. In one example embodiment, the awning 200 includes the compression actuator 300b, the gas spring 402, and the magnet actuator 500e. In on example embodiment, the awning 200 includes the compression actuator 300b, the gas spring 402, and the worm gear actuator 500f. In one example embodiment, the awning 200 includes the compression actuator 300b, the gas spring 402, and the motor driven arm cable 500g. In one example embodiment, the awning 200 includes the compression actuator 300b, the gas spring 402, and the compressor driven bladder 500h. In one example embodiment, the awning 200 includes the compression actuator 300b and the gas spring 402. In one example embodiment, the awning 200 includes the compression actuator 300b and the first motor actuator 500a, wherein no gas spring 402 is present. In one example embodiment, the awning 200 includes the compression actuator 300b and the second motor actuator 500b, wherein no gas spring 402 is present. In one example embodiment, the awning 200 includes the compression actuator 300b and the third motor actuator 500c, wherein no gas spring 402 is present. In one example embodiment, the awning 200 includes the compression actuator 300b and the fourth motor actuator 500d, wherein no gas spring 402 is present. In one example embodiment, the awning 200 includes the compression actuator 300b and the magnet actuator 500e, wherein no gas spring 402 is present. In one example embodiment, the awning 200 includes the compression actuator 300b and the worm gear actuator 500f, wherein no gas spring 402 is present. In one example embodiment, the awning 200 includes the compression actuator 300b and the motor driven arm cable 500g, wherein no gas spring 402 present. In one example embodiment, the awning 200 includes the compression actuator 300b and the compressor driven bladder 500h, wherein no gas spring 402 is present.

In one example embodiment, the awning 200 includes the spring metal actuator 300d and the compression spring 402. In one example embodiment, the awning 200 includes the spring metal actuator 300d, the compression spring 402, and the first motor actuator 500a. In one example embodiment, the awning 200 includes the spring metal actuator 300d, the compression spring 402, and the second motor actuator 500b. In one example embodiment, the awning 200 includes the spring metal actuator 300d, the compression spring 402, and the third motor actuator 500c. In one example embodiment, the awning 200 includes the spring metal actuator 300d, the compression spring 402, and the fourth motor actuator 500d. In one example embodiment, the awning 200 includes the spring metal actuator 300d, the compression spring 402, and the magnet actuator 500e. In one example embodiment, the awning 200 includes the spring metal actuator 300d, the compression spring 402, and the worm gear actuator 500f. In one example embodiment, the awning 200 includes the spring metal actuator 300d, the compression spring 402, and the motor driven arm cable 500g. In one example embodiment, the awning 200 includes the spring metal actuator 300d, the compression spring 402, and the compressor driven bladder 500h. In one example embodiment, the awning 200 includes the spring metal actuator 300d and the compression spring 402. In one example embodiment, the awning 200 includes the spring metal actuator 300d and the first motor actuator 500a, wherein no compression spring 402 is present. In one example embodiment, the awning 200 includes the spring metal actuator 300d and the second motor actuator 500b, wherein no compression spring 402 is present. In one example embodiment, the awning 200 includes the spring metal actuator 300d and the third motor actuator 500c, wherein no compression spring 402 is present. In one example embodiment, the awning 200 includes the spring metal actuator 300d and the fourth motor actuator 500d, wherein no compression spring 402 is present. In one example embodiment, the awning 200 includes the spring metal actuator 300d and the magnet actuator 500e, wherein no compression spring 402 is present. In one example embodiment, the awning 200 includes the spring metal actuator 300d and the worm gear actuator 500f, wherein no compression spring 402 is present. In one example embodiment, the awning 200 includes the spring metal actuator 300d and the motor driven arm cable 500g, wherein no compression spring 402 is present. In one example embodiment, the awning 200 includes the spring metal actuator 300d and the compressor driven bladder 500h, wherein no compression spring 402 is present.

Advantageously, the awnings 100, 200 are safer than the currently known awning, as in the event of an electrical or mechanical failure, the awning 100, 200 will close. Such closures in the event of failure prevent harm, such as if the awning is on a moving vehicle, or a user is attempting to the adjust the awning during failure, said user would not be struck by an extending awning.

The benefits, advantages, solutions to problems, and any element(s) that may cause any benefit, advantage, or solution to occur or become more pronounced are not to be construed as a critical, required, or essential features or elements of any or all the claims. The disclosure is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. An awning canopy assembly comprising:
an awning connection system coupling an awning canopy to a support structure during use, the awning connection system comprising:
a roll bar coupled to the awning canopy;
a set of arms coupled to the roll bar that support the awning canopy as the awning canopy extends from a retracted to an extended position;
a powered actuator that when providing a powered force that moves the awning canopy into the extended position; and
a retraction actuator that biases the set of arms into the retracted position, wherein responsive to interruption or cessation of the powered force provided by the powered actuator, the awning canopy moves into the retracted position.

2. The awning canopy assembly of claim 1, wherein absent the powered force, the retraction actuator causes the set of arms and the awning canopy to move into and remain in the retracted position.

3. The awning canopy assembly of claim 1, the retraction actuator biasing the set of arms into the retracted position via a retraction force, the retraction force less than the powered force.

4. The awning canopy assembly of claim 3, further comprising an extension actuator, the extension actuator providing an extension force to at least one of the set of arms, the extension force less than the retraction force.

5. The awning canopy assembly of claim 4, the extension actuator comprising at least one of a gas spring and compression spring.

6. The awning canopy assembly of claim 1, the powered actuator comprising a means for providing the powered force to move the awning canopy into the extended position.

7. The awning canopy assembly of claim 1, the retraction actuator comprising a means for providing the retraction force to move the awning canopy into the extended position.

8. The awning canopy assembly of claim 1, the set of arms comprising at least one of horizontal and lateral arms.

9. The awning canopy assembly of claim 1, the retraction actuator comprising a spring and residing within the roll bar.

10. An awning canopy assembly comprising:
an awning connection system coupling an awning canopy to a support structure during use, the awning connection system comprising:
a roll bar coupled to the awning canopy;
first and second extension arms coupled to the roll bar that supports the awning canopy as the awning canopy extends from a retracted to an extended position;
a retraction actuator coupled to the awning connection system that provides a retraction force biases the awning canopy into the retracted position;
an extension actuator coupled to one of the first or second extension arms, the extension actuator when providing an extension force biases the awning canopy into the extended position, the retraction force greater than the extension force, the extension force in an opposite direction than the retraction force; and
providing a powered force to the awning canopy assembly in a same direction as the extension force which moves the awning canopy into the extended position, the combination of the extension force and the powered force greater than the retraction force, wherein responsive to an interruption of the powered force, the awning canopy moves into the retracted position.

11. The awning canopy assembly of claim 10, wherein the third force is provided by a powered actuator comprising at least one of a motor and an air compressor.

12. The awning canopy assembly of claim 10, wherein the third force is provided by a powered actuator comprising one or more electrified magnets.

13. The awning canopy assembly of claim 10, the first and second extension arms comprising at least one of horizontal and lateral arms.

14. The awning canopy assembly of claim 10, wherein the retraction actuator comprises a spring and resides within the roll bar.

15. The awning canopy assembly of claim 10, wherein the extension actuator comprising a spring and resides within one of the first or second extension arms.

16. The awning canopy assembly of claim 10, wherein the extension actuator comprising a spring and is coupled one of the first or second extension arms.

17. A method of providing an awning canopy assembly, the method comprising:
providing a roll bar coupled to an awning canopy;
providing a set of arms coupled to the roll bar at a first end of the set of arms, and for coupling to a support structure during use at a second end of the set of arms, the set of arms supporting the awning canopy as the awning canopy extends from a retracted to an extended position;
providing a retraction actuator coupled to the awning canopy assembly that biases the set of arms into the retracted position by providing a retraction force; and
providing a powered actuator coupled to the awning canopy assembly, the powered actuator when providing a powered force moves the awning canopy into the extended position, the powered force greater than the retraction force, wherein responsive to a cessation of the powered force, the awning canopy moves into the retracted position.

18. The method of claim 17, further comprising providing an extension actuator coupled one of the set of arms, the extension actuator providing an extension force that biases the set or arms into the extended position, the extension force less than the retraction force.

19. The awning canopy assembly of claim 18, the providing the extension actuator comprises providing at least one of a gas spring and compression spring.

20. The awning canopy assembly of claim 18, the providing the retraction actuator comprises providing a spring in the roll bar.

21. A method of providing an awning canopy assembly, the method comprising:
providing a roll bar coupled to an awning canopy;
providing a set of arms coupled to the roll bar at a first end of the set of arms, and for coupling to a support structure during use at a second end of the set of arms, the set of arms supporting the awning canopy as the awning canopy extends from a retracted to an extended position;
providing a retraction actuator for coupling to the awning connection system that provides a retraction force biases the awning canopy into the retracted position;
providing an extension actuator for coupling to one of the first or second extension arms, the extension actuator when providing an extension force biases the awning canopy into the extended position, the retraction force greater than the extension force, the extension force in an opposite direction than the retraction force; and
providing a powered actuator for coupling to the awning canopy, the powered actuator provides a powered force to the awning canopy assembly in a same direction as the extension force which moves the awning canopy into the extended position, the combination of the extension force and the powered force greater than the retraction force, wherein responsive to an interruption of the powered force, the awning canopy moves into the retracted position.
